(19) United States
(12) Patent Application Publication
(10) Pub. No.: US 2024/0004726 A1
(43) Pub. Date: Jan. 4, 2024

(54) Barrier Sync Signalling

(71) Applicant: Graphcore Limited, Bristol (GB)

(72) Inventor: Stephen FELIX, Bristol (GB)

(21) Appl. No.: 18/338,451

(22) Filed: Jun. 21, 2023

(30) Foreign Application Priority Data
Jun. 30, 2022 (GB) 2209638.2

(51) Int. Cl. G06F 9/52

(52) U.S. Cl. CPC G06F 9/522

(57) ABSTRACT

A data processing device comprising: a plurality of processors, each of which has an associated sync request wire and an associated sync acknowledgment wire, both of which are used for co-ordinating barrier synchronisations. Each of the processors receives a signal representing a state of its sync acknowledgment wire, and asserts a sync request by setting a state of its sync request wire to be opposite to the state of its sync acknowledgement wire. The data processing device further comprises aggregation circuitry, which aggregates the state of the sync request wires to output an aggregate sync request to a sync controller. In response, the sync controller returns to each of the processors, an acknowledgment of the sync requests by causing the state of the sync acknowledgment wires to be set to be the same as the state of the sync request wires.

### CROSS-REFERENCE TO RELATED APPLICATIONS

The present application claims priority to United Kingdom Patent Application No. GB2209638.2, filed Jun. 30, 2022, the disclosure of which is hereby incorporated herein by reference in its entirety.

### TECHNICAL FIELD

The present disclosure relates to a data processing device, and in particular, to a data processing device comprising a sync controller for co-ordinating barrier synchronisations between processors of the data processing device.

### BACKGROUND

In the context of processing data for complex or high-volume applications, a processing unit for performing the processing of that data may be provided. The processing unit may function as a work accelerator to which processing of certain data is offloaded from a host system. Such a processing unit may have specialised hardware for performing specific types of processing.

As an example, one area of computing in which such a specialised accelerator subsystem may be of use is found in machine intelligence. As will be familiar to those skilled in the art of machine intelligence, a machine intelligence algorithm is based around performing iterative updates to a “knowledge model”, which can be represented by a graph of multiple interconnected nodes. The implementation of each node involves the processing of data, and the interconnections of the graph correspond to data to be exchanged between the nodes. Typically, at least some of the processing of each node can be carried out independently of some or all others of the nodes in the graph, and therefore large graphs expose great opportunities for multi-threading. Therefore, a processing unit specialised for machine intelligence applications may comprise a large degree of multi-threading. One form of parallelism can be achieved by means of an arrangement of multiple processor tiles on the same chip (i.e. same die), each processor tile comprising its own separate respective execution unit and memory (including program memory and data memory). Thus separate portions of program code can be run in parallel on different ones of the tiles.

When a processing device comprising a plurality of processors operating in parallel is provided, a technique is required to prevent a piece of code running on one processor from running ahead of data upon which it is dependent being made available by another piece of code running on another processor. There are a number of possible schemes for achieving this, one of which, which is described here by way of example, is ‘BSP’ (bulk synchronous parallel). According to BSP, each processor participates in a compute phase and an exchange phase in an alternating cycle. During the compute phase, a processor performs one or more computation tasks locally, but does not communicate any results of its computations with any others of the processors. In the exchange phase, each processor is allowed to exchange one or more results of the computations from the preceding compute phase to and/or from one or more others of the processors. Furthermore, according to the BSP principle, a barrier synchronization is placed at the juncture transitioning from the compute phase into the exchange phase, transitioning from the exchange phase into the compute phase, or both.

In order to co-ordinate barrier synchronisations between processors, a central sync controller may be provided for receiving sync requests from each of a set of processors that are to sync together, and returning sync acknowledgments once sync requests have been received from all of the processors participating together in the barrier synchronisation.

### SUMMARY

In order to co-ordinate barrier synchronisations between different processors, dedicated wiring may be provided in a processing device for transmitting sync requests and acknowledgments, where that wiring is in addition to the wiring for transmitting data plane traffic between the processors. One challenge that arises is how to minimise the amount of wiring require to co-ordinate barrier syncs, whilst at the same time preventing race conditions from occurring. Since, during the course of execution of an application, a processing device may participate in multiple barrier synchronisations, a race condition can occur if, whilst a first processor is asserting a sync request signal corresponding to one barrier, a second processor proceeds to issue a sync request corresponding to a later barrier. This may occur if the second processor is located closer to a sync controller, such that the second processor issues a sync request for the earlier barrier, receives a sync acknowledgement for the earlier barrier, and then proceeds to issue a synchronisation request for a following barrier, all before the first processor has received its sync acknowledgment for the earlier barrier. In this case, the first processor may deliver a sync request corresponding to the earlier barrier synchronisation to the sync controller, whilst at the same time, the second processor delivers a sync request corresponding to the later barrier synchronisation. In this case, the sync controller may proceed to issue a further sync acknowledgment, before the first processor has yet reached the later barrier.

In order to prevent such a described race condition, one proposal is to provide each processor with two sync request wires and have each processor alternate between use of one its sync request wires and the other of its sync request wires. In this way, the sync controller may distinguish between sync requests relating to one barrier synchronisation and sync requests relating to an immediately following barrier synchronisation. However, this solution requires the duplication of sync request wiring in the processing device. The duplication of sync request wiring may become particularly expensive in the case that each processor is provided with different sync request wires associated with different sync zones for syncing with different groups of processors. In such a case, duplication to prevent race conditions would require duplicating the sync request wire for each sync zone.

According to a first aspect, there is provided a data processing device comprising: a plurality of processors, each comprising an execution unit configured to participate in at least one of a plurality of barrier synchronisations; and a plurality of sets of wiring for co-ordinating the barrier synchronisations between the processors, wherein each of the sets of wiring is associated with a respective one of the processors and comprises a sync request wire and a sync acknowledgment wire, wherein for each of the processors, circuitry of the respective processor is configured to: receive a signal representing a state of the sync acknowledgment wire for the respective processor; assert a sync request by setting a state of the sync request wire for the respective processor in dependence upon the received signal, so as to be opposite to the state of the sync acknowledgement wire for the respective processor, wherein the data processing device further comprises: aggregation circuitry configured to, in response to detecting that each of the sync request wires has been set to the opposite of the state of the sync acknowledgment wires, output an aggregate sync request for a first of the barrier synchronisations to the sync controller; a sync controller comprising circuitry configured to, in response to the aggregate sync request, return to each of the processors, an acknowledgment of the sync request of the respective processor by causing the state of the sync acknowledgment wire of the respective processor to be set to be the same as the state of the sync request wire of the respective processor.

A new scheme for signalling sync requests and sync acknowledgments is provided. In accordance with this scheme, each processor, in order to signal a sync request, sets the state of its sync request wire to be the opposite to the state of its sync acknowledgement wire (e.g. the sync request signal will be set high if the sync acknowledgment is set low, whereas the sync request signal will be set low if the sync acknowledgment is set high). This state is aggregated and provided to the sync controller as an aggregate sync request. In order to provide a sync acknowledgment to the processors, the sync controller outputs a sync acknowledgment signal that has a same state as the sync request wires (e.g. the sync acknowledgment signal is set high if the sync request wires are set high, whereas the sync acknowledgment signal is set low if the sync request wires are set low). This scheme enables a processor to transmit sync requests for subsequent barrier syncs on a single wire, whilst avoiding the race condition discussed above. For example, supposing that, as discussed above, both a first processor (which is further from the sync controller) and a second processor (which is closer to the sync controller) assert a sync request by setting their sync request wire to a high state. The sync controller receives the aggregated sync request (which is also high) and, in response, issues a sync acknowledgment by setting the sync acknowledgment wires to the high state. The second processor may, by virtue of being closer to the sync controller, receive the sync acknowledgment and proceed to issue a new sync request for a following barrier sync before the first processor has received the sync acknowledgment. Following the new scheme, the second processor issues the new sync request by setting its sync request wire's state to be the opposite of the received acknowledgment, i.e. it sets its sync request wire's state to be low. The aggregation circuitry is configured to output the sync request to the sync controller in response to each of the sync request signals in the processing device being set to the opposite state of the signal acknowledgment signal. Whilst the new sync request signal output by the second processor will be set to the opposite of the currently asserted sync acknowledgment signal (i.e. the new sync request will be set low), the old sync request signal output by the first processor will still be set to be the same as the currently asserted sync acknowledgment signal (i.e. the old sync request signal output by the first processor will be set high). Since the sync controller will only receive the aggregated sync request for the next barrier once each of the sync request signals has been set low, there is no possibility of the sync controller proceeding to issue another sync acknowledgment until the first processor has also issued its sync request for the second barrier sync. The race condition discussed above is thereby avoided.

According to a second aspect, there is provided a method for co-ordinating barrier synchronisations between processors of a data processing device, the method comprising: at each of the processors: receiving a signal representing a state of a sync acknowledgment wire for the respective processor; asserting a sync request by setting a state of a sync request wire for the respective processor in dependence upon the received signal so as to be opposite to the state of the sync acknowledgement wire for the respective processor, in response to detecting that each of the sync request wires has been set to the opposite of the state of the sync acknowledgment wires, outputting an aggregate sync request for a first of the barrier synchronisations; and in response to the aggregate sync request, returning to each of the processors, an acknowledgment of the sync request of the respective processor by causing the state of the sync acknowledgment wire of the respective processor to be set to be the same as the state of the sync request wire of the respective processor.

In some embodiments, the method comprises outputting the aggregate sync request on an aggregate sync request wire by: following a transition in the state of all of the sync request wires to an updated state, updating a state of the aggregate sync request wire to match the updated state of all of the sync request wires.

In some embodiments, the method comprises generating the aggregate sync request by, for each of a set of one or more of the processors, aggregating the state of the sync request wires of the respective set of one or more of the processors with running aggregate state.

In some embodiments, the method comprises, at each of at least some of the processors, in response to the acknowledgment from the sync controller, proceed past the first of the barrier synchronisations.

In some embodiments, the method comprises, at each of the processors: storing a local program comprising a set of computer readable instructions, the respective set of computer readable instructions comprising indications of each of ones of the barrier synchronisations in which the respective processor is to participate; and executing the computer readable instructions of the respective processor so as to enable the respective processor to participate in ones of the barrier synchronisations.

In some embodiments, the method comprises, for each of at least some of the processors, in response to a first of the indications for the first of the barrier synchronisations, executing a sync instruction to cause the circuitry of the respective processor to assert the sync request for the respective processor.

In some embodiments, the method comprises, each of the processors operating in an alternating cycle of compute phases and exchange phases separated by the barrier synchronisations.

In some embodiments, the method comprises, at each of at least some of the processors: in response to receipt of the acknowledgment of the sync request of the respective processor, proceeding to one of the exchange phases in which each of the at least some of the processors at least one of: sends or receives data.

In some embodiments, the method comprises, at each of a subset of the processors: storing an indication that the respective processor does not belong to a group of processors that are configured to participate in the first of the barrier synchronisations; and asserting the sync request of the respective processor in response to the indication that the respective processor does not belong to the group.

In some embodiments, for each of the subset of the processors: an execution unit of the respective processors is configured to, following assertion of the sync request by the circuitry of the respective processor and prior to receipt of the acknowledgment, proceed with computation or data exchange without waiting at the first of the barrier synchronisations.

In some embodiments, for each of the subset of the processors: in response to the indication that the processor does not belong to the sync group, abstaining from participating in the one of the exchange phases.

In some embodiments, the method comprises: in response to the aggregate sync request, issuing a further request to an external sync controller for the processors to participate in the first of the barrier synchronisations with further processors belonging to further devices; and subsequently, in response to receipt of a further acknowledgment of the further request from the external sync controller, returning to each of the processors, the acknowledgment of the sync request of the respective processor.

In some embodiments, for each of the processors, the respective sync request wire and the respective sync acknowledgment are associated with a first sync group to which at least some of the processors belong.

In some embodiments, the method comprises, for each of the processors: on each of a plurality of further sync request wires associated with the respective processor, transporting further sync requests for ones of the barrier synchronisations involving a sync group associated with the respective further sync request wire; and on each of a plurality of further sync acknowledgment wires associated with the respective processor, transporting further sync acknowledgments in relation to ones of the barrier synchronisations involving a sync group associated with the respective further sync acknowledgment wire.

In some embodiments, each of the different sync groups is a configurable sync group, wherein the method comprises, storing in each of the processors an indication, for each of the configurable sync groups, whether or not the respective processor belongs to that configurable sync group.

In some embodiments, the method comprises: for each of the processors, at least one of: an inverting at an inverter gate, the signal representing the state of the sync acknowledgment wire for the respective processor in order to set the state of the sync request wire for the respective processor to be opposite to the state of the sync acknowledgement wire for the respective processor; and inverting at an XOR gate, the signal representing the state of the sync acknowledgment wire for the respective processor in order to set the state of the sync request wire for the respective processor to be opposite to the state of the sync acknowledgement wire for the respective processor.

In some embodiments, for each of the processors: the signal representing the state of the sync acknowledgment wire for the respective processor is a low signal; the setting the state of the sync request wire for the respective processor comprises setting the state of sync request wire to a high state; wherein the method comprises, for each of the processors, following assertion of its sync request: receiving a further signal representing an updated state of the sync acknowledgment wire for the respective processor, the further signal being a high signal and representing the acknowledgment of the sync request of the respective processor; and asserting a further sync request by setting the state of the sync request wire for the respective processor to a low state.

In some embodiments, for each of at least some of the processors, detecting the acknowledgment of the sync request for the respective processor in response to detecting a transition in the state of the sync acknowledgment wire for the respective processor.

In some embodiments, the data processing device is an integrated circuit.

### BRIEF DESCRIPTION OF DRAWINGS

For a better understanding of the present invention and to show how the same may be carried into effect, reference will now be made by way of example to the accompanying Figures in which:

FIG. 1 illustrates an example of a multi-tile processing unit;

FIG. 2 is a schematic diagram illustrating the compute and exchange phases within a multi-tile processing unit;

FIG. 3 illustrates exchange of data in a bulk synchronous parallel system;

FIG. 4 is a schematic illustration of internal and external synchronisation barriers;

FIG. 5 is a schematic illustration of an integrated circuit comprising a multi-tile processing unit and sync controller circuitry;

FIG. 6 is a schematic illustration of a processor tile;

FIG. 7 illustrates a timeline of the state of a sync request wire of a tile and the corresponding sync acknowledgment wire of that tile;

FIG. 8A is a schematic illustration of a sync output interface of a tile for outputting sync requests towards a sync controller for the processing unit;

FIG. 8B is a schematic illustration of a sync input interface comprising circuitry for producing a sync ack pulse in response to an edge in the sync acknowledgment signal;

FIG. 9 is a schematic illustration of the sync aggregation circuitry for aggregating sync request state of all tiles of the processing unit for delivery to the sync controller;

FIG. 10 is a schematic illustration of the sync distribution wiring for delivering a sync acknowledgment signal to all of tiles of the processing unit;

FIG. 11 is a schematic illustration of circuitry for aggregating sync request state output by two pair tiles with upstream sync request state;

FIG. 12 is a schematic illustration of circuitry for aggregating sync request state for a column of tiles;

FIG. 13 is a schematic illustration of circuitry for aggregating sync request state from multiple columns of tiles;

FIG. 14A is a schematic illustration of circuitry within a sync controller for providing a sync acknowledgment in response to receipt of a sync request for the processing unit;

FIG. 14B is a schematic illustration of a sync signalling scheme used for signalling external sync request and acknowledgements;

FIG. 15 is a schematic illustration of the division of tiles of a processing unit between different sync zones and the transmission of sync requests by the tiles of those zones;

FIG. 16 is a schematic illustration of the division of tiles of a processing unit between different sync zones and the delivery of sync acknowledgments to the tiles of those zones;

FIG. 17 is a schematic illustration of the exchange of sync requests and acknowledgments between GSPs in the system;

FIG. 18 is a schematic illustration of a system in which external sync zones are implemented; and

FIG. 19 is an illustration of an example sync network.

FIG. 20 illustrates a method for co-ordinating synchronisations between processors based on configurable sync groups.

FIG. 21 illustrates a method for co-ordinating synchronisations using a new scheme for signalling sync requests and acknowledgments.

### DETAILED DESCRIPTION

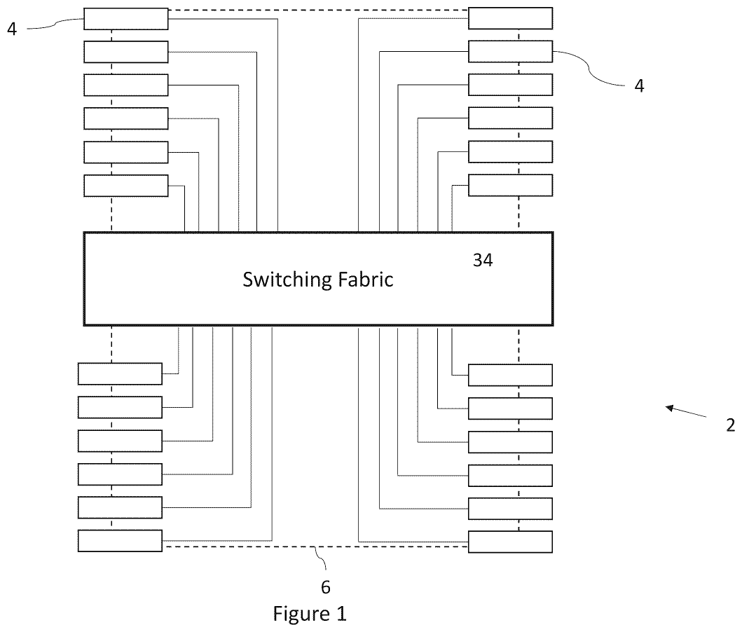

Reference is made to FIG. 1, which illustrates an example processing unit 2 comprising a plurality of processors 4. In the described embodiments, the processors 4 are presented as being tiles 4. However, the tiles 4 may be described more generally as being processors 4. Each such processing unit 2 is formed on an integrated circuit. The multi-tile processing unit 2 shown is described in U.S. patent application Ser. No. 15/886,065, which is incorporated by reference.

The processing unit 2 comprises an array 6 of multiple processor tiles 4 and an interconnect 34 connecting between the tiles 4. The processing unit 2 may be implemented alone as one of multiple dies packaged in the same IC package. The interconnect 34 may also be referred to herein as the “exchange fabric” 34 as it enables the tiles 4 to exchange data with one another. Each tile 4 comprises a respective instance of an execution unit and memory. For instance, by way of illustration, the processing unit 2 may comprise of the order of hundreds of tiles 4, or even over a thousand. For completeness, note also that an “array” as referred to herein does not necessarily imply any particular number of dimensions or physical layout of the tiles 4.

In embodiments, each processing unit 2 also comprises one or more external links, enabling the processing unit 2 to be connected to one or more other processing units (e.g. one or more other instances of the same processing unit 2). These external links may enable the processing unit 2 to be connected to: a host system; and one or more other instances of the processing unit 2 on the same IC package or card, or on different cards. The processing unit 2 receives work from the host, in the form of application data which it processes.

The interconnect 34 is configured to enable the different tiles 4 in the array 6 to communicate with one another. However, as well as there potentially being dependencies between threads on the same tile 4, there may also exist dependencies between the portions of the program running on different tiles 4 in the array 6. A technique is therefore required to prevent a piece of code on one tile 4 running ahead of data upon which it is dependent being made available by another piece of code on another tile 4. This is achieved using a data consistency model.

Parallel programming models for Al and Data Science usually follows a 3-phase iterative execution model: Compute, Barrier, and Exchange. The implications are that data transfer to and from a processor is usually barrier dependent to provide data-consistency between the processors, and between each processor and an external storage. Typically used data consistency models are Bulk Synchronous Parallel (BSP), Stale Synchronous Parallel (SSP) and Asynchronous. The processing unit 2 described herein uses a BSP model, but it will be apparent that the other sync models could be utilised as an alternative.

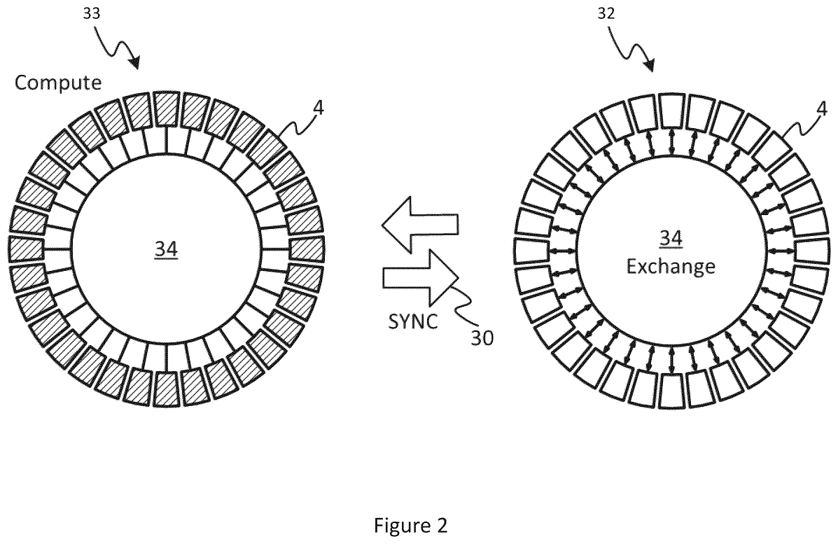

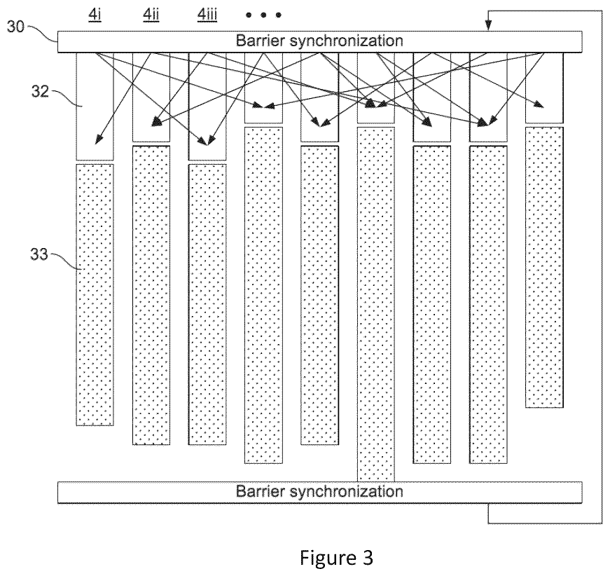

Reference is made to FIGS. 2 and 3, which illustrate an implementation of a BSP exchange scheme, in which each tile 4 performs a compute phase 33 and an exchange phase 32 in an alternating cycle, separated from one to the other by a barrier synchronization 30 between tiles 4. In the case illustrated by FIGS. 2 and 3, a barrier synchronization is placed between each compute phase 33 and the following exchange phase 32. During the compute phase 33, each tile 4 performs one or more computation tasks locally on-tile, but does not communicate any results of these computations with any others of the tiles 4. In the exchange phase 32, each tile 4 is allowed to exchange one or more results of the computations from the preceding compute phase to and/or from one or more others of the tiles 4, but does not perform any new computations until it has received from other tiles 4 any data on which its task(s) has/have dependency. It is not excluded that other operations such as internal control-related operations may be performed in the exchange phase 32. The communication external to the tile group may optionally utilise the BSP mechanism, but alternatively may not utilize BSP and may instead use some other synchronization mechanism of its own.

According to the BSP principle, a barrier synchronization 30 is placed at the juncture transitioning from the compute phase 33 into the exchange phase 32, or the juncture transitioning from the exchange phase 32 into the compute phase 33, or both. That is to say, either: (a) all tiles 4 are required to complete their respective compute phases 33 before any in the group is allowed to proceed to the next exchange phase 32, or (b) all tiles 4 in the group are required to complete their respective exchange phases 32 before any tile in the group is allowed to proceed to the next compute phase 33, or (c) both of these conditions are enforced. In all three variants, it is the individual tiles 4 which alternate between phases, and the assembly which synchronizes. The sequence of exchange and compute phases may then repeat over multiple repetitions. In BSP terminology, each repetition of exchange phase and compute phase is sometimes referred to as a “superstep” (though note that in the literature the terminology is not always used consistently: sometimes each individual exchange phase and compute phase individually is called a superstep, whereas elsewhere, as in the terminology adopted herein, the exchange and compute phases together are referred to as a superstep).

FIG. 3 illustrates the BSP principle as implemented amongst a group 4i, 4ii, 4iii of some or all of the tiles in the array 6, in the case which imposes: (a) a barrier synchronization from compute phase 33 to exchange phase 32 (see above). Note that, in this arrangement, some tiles 4 are allowed to begin computing 33 whilst some others are still exchanging.

The BSP model may be used for the exchange of data between tiles 4 on the processing unit 2. The communication between tiles 4 of a processing unit 2 occurs in time deterministic fashion, in which data packets are transmitted without headers as in our earlier application U.S. patent application Ser. No. 15/886,065. Additionally, the BSP model may also be used for the exchange of data between processing units 2.

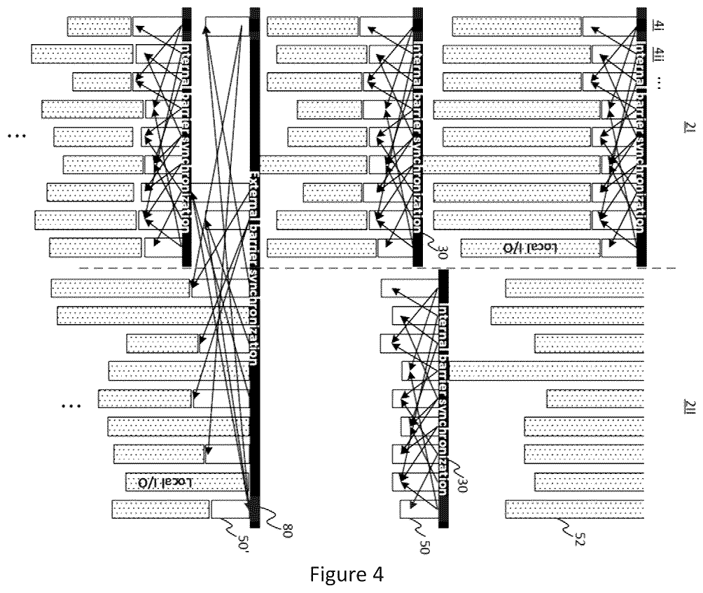

Reference is made to FIG. 4, which illustrates an example BSP program flow involving both internal (i.e. between tiles 4 of a single processing unit 2) and external (i.e. between processing units 2) synchronizations. As shown, the flow comprises internal exchanges 50 (of data between tiles 4 of the same processing unit 2) and an external exchange 50′ (of data between tiles 4 of different processing units 2). The program flow in FIG. 4 illustrates a program flow for a first processing unit 2i and a second processing unit 2ii.

As illustrated in FIG. 4, the internal BSP supersteps (comprising the internal exchanges 50 of data between tiles 4 of the same processing unit 2) are kept separate from the external sync and exchange (comprising the external exchanges 50′ of data between tiles 4 of different processing units 2).

The program may be arranged to perform a sequence of synchronizations, exchange phases and compute phases comprising, in the following order: (i) a first compute phase, then (ii) an internal barrier synchronization 30, then (iii) an internal exchange phase 50, then (iv) an external barrier synchronization 80, then (v) an external exchange phase 50′. The external barrier 80 is imposed after the internal exchange phase 50, such that the program only proceeds to the external exchange 50′ after the internal exchange 50. Note also that, as shown with respect to processing unit 2l in FIG. 4, optionally a compute phase may be included between (iii) internal exchange and (iv) external barrier.

This overall sequence is enforced by the program (e.g. being generated as such by the compiler). In embodiments, the program is programmed to act in this way by means of a SYNC instruction executed by the tiles 4. The internal synchronization and exchange does not extend to any tiles or other entities on another processing unit 2. The sequence (i)-(v) (with the aforementioned optional compute phase between (iii) and (iv)) may be repeated in a series of overall iterations. Per iteration there may be multiple instances of the internal compute, sync and exchange (i)-(iii) prior to the external sync & exchange. I.e. multiple instances of (i)-(iii) (retaining that order), i.e. multiple internal BSP supersteps, may be implemented before (iv)-(v), i.e. the external sync and exchange. Note also, any of the tiles 4 may each be performing their own instance of the internal synchronization and exchange (ii)-(iii) in parallel with the other tiles 4.

Thus per overall BSP cycle (i)-(v) there is at least one part of the cycle (ii)-(iii) wherein synchronization is constrained to being performed only internally.

Note that during an external exchange 50 the communications are not limited to being only external: some tiles 4 may just perform internal exchanges, some may only perform external exchanges, and some may perform a mix.

Also, as shown in FIG. 4, some tiles 4 may perform local input/output during a compute phase. For example, they may exchange data with a host or other type of external storage.

Note also that, as shown in FIG. 4, it is in general possible for any or all tiles to have a null compute phase 52 or a null exchange phase 50 in any given BSP superstep.

For both internal barrier synchronisations and external barrier synchronisations, the tiles 4 taking part in the barrier synchronisation are referred to as a synchronisation group. A set of configurable synchronisation groups is supported by the processing unit 2, where each of these configurable synchronisation groups is referred to herein as a synchronisation zone. Each of the tiles 4 may subscribe to a particular synchronisation zone, thus permitting an arbitrary group of tiles to sync together. Each of the synchronisation zones is individually configurable to comprise different synchronisation groups of tiles 4 in dependence upon settings for the respective synchronisation zone. By modifying these settings individual tiles 4 may be associated or disassociated with synchronisation zones. A synchronisation zone supported for a particular processing unit 2 may be configured as internal, in which case the tiles 4 of that processing unit 2 that are subscribed to that zone only sync with one another. On the other hand, a synchronisation zone supported for a particular processing unit 2 may be configured as external, in which case, the zone extends across multiple processing units 2, with tiles 4 of one processing unit 2 participating in the zone synchronising with tiles 4 of another processing unit 2 participating in the zone.

For each of the tiles 4 of a processing unit 2 that belong to a synchronisation zone, once that tile 4 reaches a barrier synchronisation, it issues a sync request. The sync request issued by the tiles 4 are aggregated to form an internal sync request which is provided to sync logic for the processing unit 2. In embodiments, the sync logic comprises an internal sync controller 55 and an external sync controller 58, which are described in more detail later. In response to receipt of an internal sync request may, prior to acknowledging the request, propagate an external sync request to a further entity of the sync zone. The further entity could be a proxy for exchanging data with a host system or sync logic associated with another processing unit 2.

Where an external sync request is propagated to sync logic associated with another processing unit 2, the action taken by the sync logic associated with that other processing unit 2 in response to the external sync request depends upon whether that logic is defined as the master for the sync zone or as a propagation node for the sync zone. The propagation nodes for a sync zone propagate their received external sync requests towards the master defined for the sync zone. The sync master, once it has received external sync requests for each of the processing units 2 containing tiles 4 belonging to the sync zone, returns external sync acknowledgments to the sync logic associated with each of those other processing units 2 (apart from its own processing unit 2) containing tiles 4 belonging to the sync zone. The sync master also causes sync acknowledgments to be returned to each of the tiles 4 in its own processing unit 2. The sync logic (which comprises a propagation node) associated with each of the processing units 2, upon receiving an external sync acknowledgment originating from the sync master, returns sync acknowledgments to those tiles 4 of its processing unit 2. In response to receiving the sync acknowledgements, the tiles 4 of the sync zone pass the barrier synchronisation and exchange data with one other during the exchange phase. This exchange of data between different processing units 2 is done in a non-time deterministic manner as described in our earlier application, U.S. application Ser. No. 15/886,065.

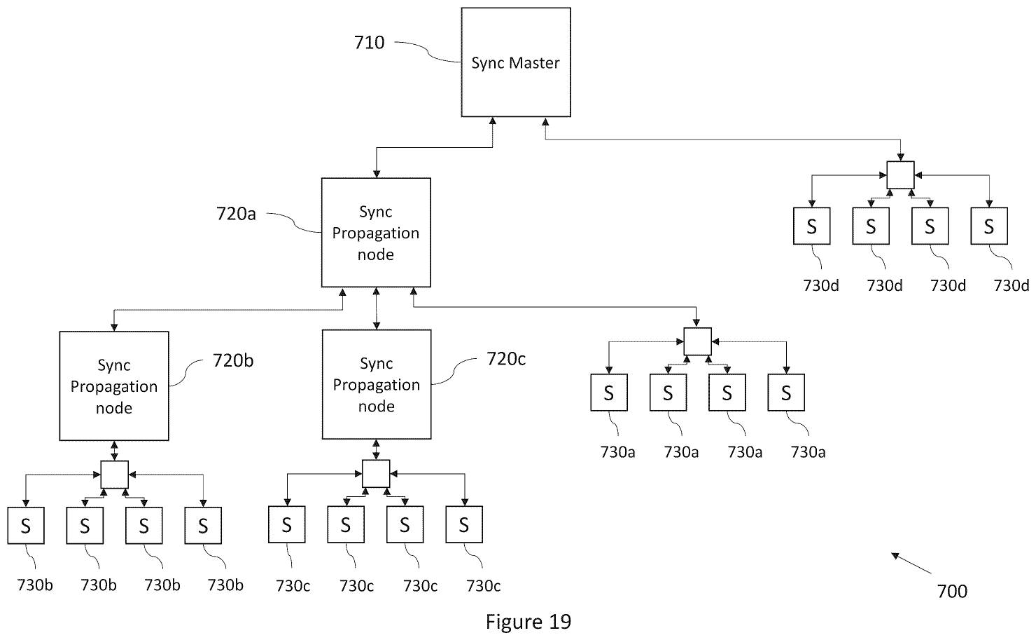

In this description, the term sync network is used to refer to the connected sync propagation nodes/circuits for a sync zone that are used to exchange sync requests/acknowledgments so as to co-ordinate a barrier synchronisation between tiles 4 belonging to a sync zone. Sync requests transmitted towards the master node defined in the sync network are said to be transmitted “upstream” in the sync network. Sync acknowledgements transmitted towards the slave nodes defined in the sync network are said to be transmitted “downstream” in the sync network. The concept of a sync network is described in further detail with respect to FIG. 19.

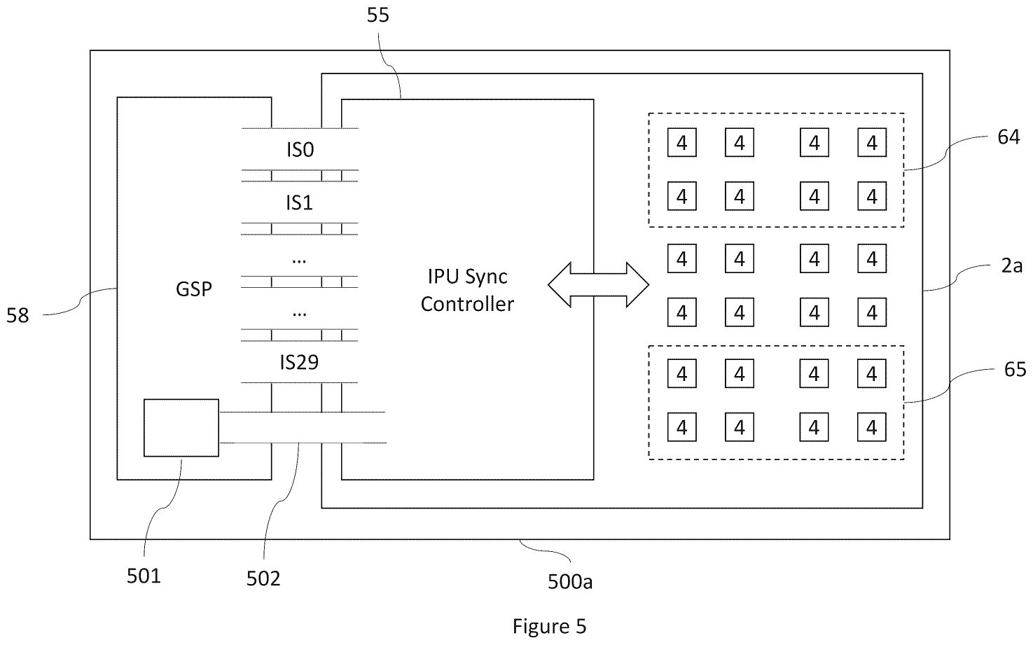

Reference is made to FIG. 5, which illustrates an example of an integrated circuit 500a (i.e. a chip 500a). A plurality of similar such chips may be connected together. In the remainder of this description, the connected chips, of which the example chip 500a is one, are referred to as chips 500. Each chip 500 comprises a processing unit 2 comprising tiles 4. Each chip 500 may also be referred to as a processing device 500 or as an accelerator subsystem 500, since the processing unit 2 of each chip 500 functions as an accelerator for processing workloads provided by a host system. Although the processing devices 500 are described as being chips 500 throughout this description, it is not excluded that in some embodiments, such processing devices 500 could be implemented on the same integrated circuit.

To identify it from amongst the plurality of chips 500, the specific chip shown in FIG. 5 is referred to as chip 500a. Similarly, to identify it from amongst the plurality of processing unit 2, the specific processing unit shown in FIG. 5 is referred to as processing unit 2a. The features of the chip 500a and processing unit 2a described below, are also features of each of the chips 500 and processing units 2.

Each of the tiles 4 in the processing unit 2a may participate in different types of barrier sync. AA first type of barrier sync is an internal sync, in which only tiles 4 of the same processing unit 2a participate.

A second type of sync is an external wired sync in which the sync zone for the sync, in addition to including tiles 4 of processing unit 2a, also includes tiles 4 on one or more chips 500 that are accessible over local wired connections. For the external wired sync, the sync messages are exchanged between the chips 500 over dedicated wires used for the transmission of different types of sync message. The application data that is exchanged between the chips 500 during the exchange phase for an external wired sync is sent over PCIe connections between the chips 500 participating in the sync.

A third type of sync is an external sync with host involvement. In this case, a host sync proxy (HSP) participates in the barrier sync by exchanging sync messages with the processing unit 2a, prior to an exchange phase in which data is exchanged between the host and the tiles 4 of the processing unit 2a.

A fourth type of sync is an external packet-based sync in which the sync group for the sync, in addition to including tiles 4 of processing unit 2a, also includes tiles 4 on one or more chips 500 that are accessible over a packet-switch network (e.g. an Ethernet network). For the external packet-based sync, in addition to sending the application data between the chips 500 over a packet-switched network, the sync messages are also sent over the same packet-switched network.

To enable each of the tiles 4 in the processing unit 2a to participate in the different types of sync, a plurality of sync zones are provided for the processing unit 2a. In embodiments, there are 30 different sync zones provided for the processing unit 2a, with each of these sync zones being configurable to include one or more of the tiles 4 of the processing unit 2a. Each sync zone is individually configurable to comprise different sync groupings of tiles 4.

Each of the sync zones may be configured as an external sync zone (in which case the corresponding sync group includes tiles 4 of other processing units 2) for an external barrier synchronisation or as an internal sync zone (in which case the sync group for that sync zone is limited to tiles 4 of the processing unit 2a) for an internal barrier synchronisation.

The sync zones may be categorised into different sets depending upon the hardware provided for that sync zone and, consequently, the type of syncs that be implemented using that sync zone. A first set of the sync zones are sync zones that may be configured for use for either for the first type of sync discussed above (i.e. internal sync) or the second type of sync discussed above (i.e. external wired sync). In the embodiments in which there are 30 sync zones defined for the processing unit 2a, the first 22 of these zones (labelled sync zones 1-22) belong to the first set of sync zones.

Of the first set of sync zones, a subset of these sync zones may also be used for communication with host involvement, i.e. they may be used for the third type of sync discussed above. In embodiments in which the first set of sync zones comprises 22 sync zones, two of these sync zones (labelled sync zones 1 and 2) may be used for barrier synchronisations following which data exchange is carried out between the host and the tiles 4 of the processing unit 2a.

A second set of the sync zones are sync zones that may be used either for the first type of sync discussed above (i.e. internal sync) or the fourth type of sync discussed above (i.e. external packet-based sync). In the embodiments in which there are 30 sync zones defined for the processing unit 2a, the last eight of these zones (labelled sync zones 23-30) belong to the second set of sync zones.

As described above, in order to co-ordinate synchronisations between different tiles 4 that are part of a sync zone, an exchange of synchronisation requests and synchronisation acknowledgments is performed between the tiles 4. The paths through the sync network by which the sync requests are propagated and acknowledged will depend upon the configuration setting for the sync zone that are in use in order to co-ordinate the sync between the tiles 4 belonging to the sync group.

In the following description, multiple types of sync request and acknowledgment signals are described for use in different parts of the sync network. To distinguish these signals, the following terminology is adopted.

Each tile 4 has a sync request wire for each sync zone. The state of this wire is referred to herein as tile sync request state. When the state of the wire is set to indicate that a sync request is asserted by the tile 4, the resulting sync request is referred to as a tile sync request. Each tile 4 comprises an execution unit 52, which may control the state of the sync request wires. For any such wire, the signal output by the execution unit 52 and used to assert a tile sync request on that wire is referred to as the sync control signal.

Each tile 4 also has a sync acknowledgment wire for each sync zone. The state of this wire is referred to herein as the internal sync acknowledgment state. When the state of the wire indicates a sync acknowledgment is asserted by the tile 4, the resulting sync acknowledgment is referred to as an internal sync acknowledgement. The execution unit 52 is responsive to pulses generated in response to edges in the internal sync acknowledgment state. Such a pulse is referred to herein as a sync ack pulse.

Aggregation circuitry is provided in the processing unit 2a for aggregating the sync request state of all of the tiles 4 in the processing unit 2a. The state of the signal output by each such unit of aggregation circuitry is referred to herein as aggregate sync request state, and a sync request signalled by the aggregate sync request state is referred to as an aggregate sync request. The aggregate sync request state of all of the tiles 4 of the processing unit 2a is referred as internal aggregate sync request state and a sync request signalled by such state is referred to as an internal sync request. Such an internal sync request is provided as an input to the internal sync controller 55, which responds by outputting a corresponding internal sync acknowledgment. This internal sync acknowledgment is propagated to all of the tiles 4 of the processing unit 2a.

The internal sync controller 55 for certain configured sync zones, outputs a sync request to the external sync controller (the GSP 58) in response to the internal sync request. This sync request is referred to as an external sync request. The GSP 58 responds by returning a sync acknowledgment to the internal sync controller 55. This returned acknowledgment is referred to as external sync acknowledgment.

FIG. 5 shows that the processing unit 2a includes sync controller circuitry 55 (shown as the IPU sync controller 55) between the tiles 4 and the GSP 58. The IPU sync controller 55 may also be referred to as the internal sync controller 55, since it acknowledges internal sync requests for internal barrier synchronisations without requiring input from the GSP 58. The IPU sync controller 55 receives internal sync requests represented by aggregate sync request state output by the tiles 4, and performs an action in dependence upon settings in a register 501 of the GSP 58. The settings in the register 501 define for each sync zone whether that sync zone is defined as internal or as external. Indications of the settings in register 501 are provided to the IPU sync controller 55 over interface 502 between the GSP 58 and the IPU sync controller 55. Any of the 30 sync zones may be defined as either external or internal.

When an internal sync request is received at the IPU sync controller 55 and the sync zone for that sync request is defined in register 501 as being an external sync zone, the IPU sync controller 55 responds by providing an external sync request to the GSP 58 on an interface of the GSP 58 associated with the particular sync zone for the sync. As shown in FIG. 5, the GSP 58 has a number of interfaces (labelled as IS0 to IS29), each of which is associated with one of the sync zones provided for the processing unit 2a. The sync controller 55 provides the external sync request over one of the interfaces (IS0 to IS29) that is associated with the same sync zone as the internal sync request. In response, the GSP 58 will return an external sync acknowledgment, which is sent over the same one of the interfaces IS0 to IS29 over which the external sync request was provided. In response to the external sync acknowledgment returned from the GSP 58, the sync controller 55 outputs an internal sync acknowledgement to each of the tiles 4 in the processing unit 2a.

When an internal sync request associated with a particular sync zone is received at the IPU sync controller 55, if that sync zone is defined in register 501 as being as internal sync zone, the IPU sync controller 55 causes an internal sync acknowledgment to be sent to the tiles 4 of the processing unit 2a. The IPU sync controller 55 performs this action without waiting for an external sync acknowledgment from the GSP 55 The IPU sync controller 55 may, however, also pass an external sync request signal to the GSP 58, such that it is asserted on an interface of the GSP 58 that is associated with the sync zone. This enables the GSP 58 to log trace data for the sync.

To send and receive internal sync requests and internal sync acknowledgments, the IPU sync controller 55 includes a plurality of sets of wires, with each set of wires being associated with a different sync zone. Each set of wires includes at least a sync request wire, on which an internal sync request for the respective sync zone is received, and a sync acknowledgment wire on which an internal sync acknowledgment for the respective sync zone is sent to the tiles 4.

To send and receive external sync requests and external sync acknowledgments, the IPU sync controller 55 includes a plurality of sets of wires, with each set of wires being associated with a different sync zone. Each set of wires is also associated with a different one of the GSP 58 interfaces IS0 to IS29 and is used to pass external sync requests to the GSP 58 and receive external sync acknowledgments from the GSP 58 for the respective sync zone.

In order to ensure that each tile 4 indicates in which sync zone it is to participate, each individual tile 4 also has a plurality of dedicated sync request wires, each of which is associated with one of the sync zones defined for the processing unit 2a. Each tile 4, when it is to participate in a barrier synchronisation associated with a particular sync zone, issues a tile sync request on a sync request wire associated with that sync zone. Each tile 4 also has a plurality of dedicated sync acknowledgment wires, each of which is associated with one of the sync zones defined for the processing unit 2a. Each tile 4, after issuing a tile sync request on a sync request wire for a sync zone, receives from the sync controller 55, the internal sync acknowledgment on its sync acknowledgment wire associated that sync zone. In response, the tile 4 then progress to the exchange phase following the barrier synchronisation.

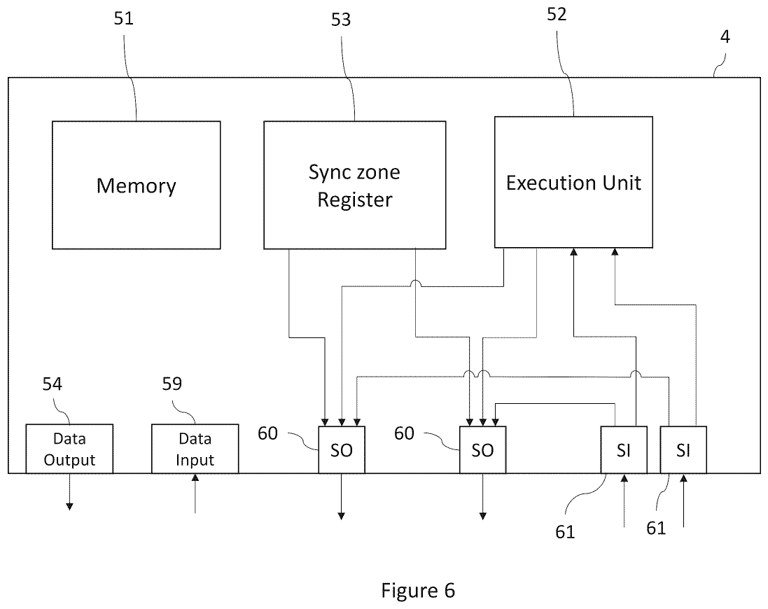

Reference is made to FIG. 6, which illustrates an example of a tile 4 according to example embodiments of the application. The tile 4 comprises a memory 51 for storing both instructions for execution by the execution unit 52 and data that the execution unit 52 is configured to perform operations on when executing the instructions. The memory 51 comprises a local program for its respective tile 4, where that local program comprises instructions to be executed by the execution unit 52. The set of instructions (or code) for each tile 4 comprise indications of synchronisation points at which the tile 4 is to participate in a barrier synchronisation. The indications comprise SYNC instructions, which are for execution by the respective execution unit 52 when the tile 4 reaches the synchronisation point in its local program. Each such SYNC instruction described below is executed when the execution unit 52 of the respective tile 4 reaches a given synchronisation point, and causes a sync request to be issued to the sync controller in relation to the barrier synchronisation to be performed at that synchronisation point.

The tile 4 comprises a sync zone register 53, which stores, for each of the plurality of sync zones defined for processing unit 2, an indication as to whether or not the tile 4 belongs to the respective sync zone. The sync zone register 53 comprises a bitmap, where each bit indicates whether or not the tile 4 belongs to a different one of the sync zones.

In order to modify the sync zones to which it belongs, the execution unit 52 of the tile 4 may execute instructions to modify the indications held in the sync zone register 53. In some embodiments, the sync zones to which each of the tiles 4 of the processing unit 2a belong are fixed for a particular application. In other embodiments, during the running of an application, the execution units 52 of one or more tiles 4 of the processing unit 2a execute instructions to modify the sync zone indications held in their registers 53 in order to change the sync zones to which they belong.

The tile 4 comprises a data output interface 54, which is used for sending, during internal exchange phases, data to other tiles 4 belonging to the same processing unit 2a and for sending, during external exchange phases, data to destinations external to the device 500a. The tile 4 comprises a data input interface 59, which is used for receiving, during internal exchange phases, data from other tiles 4 belonging to the same processing unit 2a and for receiving, during external exchange phases, data from sources external to the device 500a.

The tile 4 comprises a plurality of sync output interfaces 60, which are used for outputting tile sync request state from the tile 4 towards the internal sync controller 55. The tile 4 also comprises a plurality of sync input interfaces 61 for receiving internal sync acknowledgments from the sync controller 55 and notifying the execution unit 52. Each of the sync output interfaces 60 is associated with a different sync zone and is used for sending a tile sync request for its associated sync zone on a corresponding sync request wire. Each of the sync input interfaces 61 is associated with a different sync zone and is used for receiving an internal sync acknowledgment for its associated sync zone on a corresponding sync acknowledgment wire. Although, for simplification, the tile 4 is shown as comprising only two sync output interfaces 60 and two sync input interfaces 61, in practice the tile 4 would comprise more than two (e.g. 30) of each type of interface 60, 61.

The tile 4 is configured to output a tile sync request for a sync zone by setting the state of the relevant sync request wire to the opposite of the state of the corresponding sync acknowledgment wire for the sync zone. For example, if the internal sync acknowledgment signal for a particular sync zone is set low, in order to assert a tile sync request, the signal on the corresponding sync request wire is set high. Conversely, if the internal sync acknowledgment signal for a particular sync zone is set low, in order to assert a tile sync request, the signal on the corresponding sync request wire is set high.

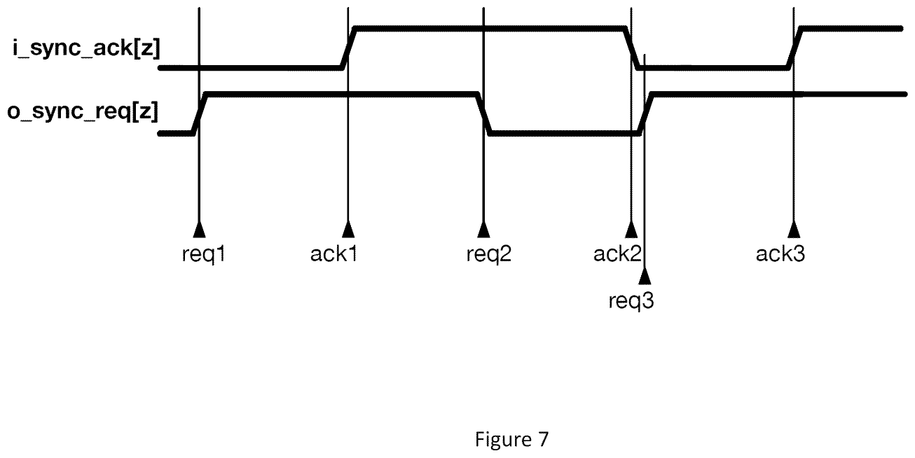

Reference is made to FIG. 7, which illustrates a timeline over which a plurality of tile sync requests are issued by a tile 4. The sync request and acknowledgment signals shown are for a particular sync zone, labelled ‘z’, in which the tile 4 is configured to participate. Hence, the sync request wire, output interface 60, sync acknowledgment wire, and input interface 61 that are discussed are those for sync zone z.

Initially, the state of sync acknowledgment wire of the tile 4 is held low. The execution unit 52 of the tile 4 executes a SYNC instruction to cause a tile sync request (i.e. req1) to be asserted on the sync request wire. Circuitry of the output interface 60 causes the tile sync request (i.e. req1) to be issued by setting the state of the sync request wire to be opposite to the state of the sync acknowledgment wire. Since the acknowledgment wire is held in a low state, the tile sync request is issued by setting the state of the sync request wire to be high. The tile sync request is represented by the transition of the sync request signal from low to high.

At some point following the assertion of the tile sync request, an internal sync acknowledgment (i.e. ack1) is received at the input interface 61 the tile 4. The internal sync acknowledgment is detected when the sync acknowledgement wire changes state, i.e. when an edge in the received sync acknowledgment is detected. Following the issuance of the tile sync request ‘req1’, the sync request wire of the tile 4 is held in a high state. The internal sync acknowledgment ‘ack1’ is received at the tile 4 once the sync acknowledgment wire is also set to a high state. Once the transition reflecting the reception of ‘ack1’ has occurred, the sync request wire and the sync acknowledgment wire are then both held in the high state. Since both wires are held in the same state, the tile sync request (i.e. req1) is no longer asserted. The transition point at which ack1 is received, therefore, also reflects the point at which req1 is deasserted.

After ack1 is received, the execution unit 52 moves into the exchange phase during which it may execute one or more SEND instructions to cause data from memory 51 to be sent over the data output interface 54.

To participate in a further barrier synchronisation, the execution unit 52 executes a further SYNC instruction to causes a further tile sync request (i.e. req2) to be issued. In this case, since the corresponding sync acknowledgment wire is set to a high state, the further tile sync request (i.e. req2) is issued by setting the sync request wire to a low state. The tile sync request remains asserted until the corresponding acknowledgment (i.e. ack2) is received when the sync acknowledgment wire is set to a low state.

Following the receipt of ack2, the execution unit 52 proceeds to execute a further SYNC instruction causing the next tile sync request (i.e. req3) to be issued by setting the sync request wire to be set to a high state. This tile 4 sync request remains asserted until the sync acknowledgment wire is also set to a high state, marking the receipt of ack3.

As shown in FIG. 6, in addition to the execution unit 52, the values of the sync zone register 53 may be used to control the state of the sync request wires. The control of the state of the sync request wires in dependence upon the values within the sync zone register 53 enables a barrier sync for a particular sync zone to proceed even if the tile 4 does not belong to that particular sync zone and is not configured to participate. Supposing that for a particular sync zone, the sync zone register 53 comprises an indication that the tile 4 does not belong to that sync zone. In that case, the sync output interface 60 for that particular sync zone is configured to output a tile sync request in response to the indication in the register 53 that the tile 4 does not belong to that sync zone. As long as the indication in register 53 is such that the tile 4 does not belong to the sync zone, the sync output interface 60 continues to output the tile sync request irrespective of the activity of the execution unit 52. The execution unit 52 may continue to execute additional instructions for performing computations during a compute phase or may execute SYNC instructions to participate in barrier synchronisations with respect to other sync zones. In this way, the tile 4 may operate asynchronously with respect to the compute-exchange cycles of the other tiles 4 that do belong to the sync zone in which the tile 4 of FIG. 6 is not participating.

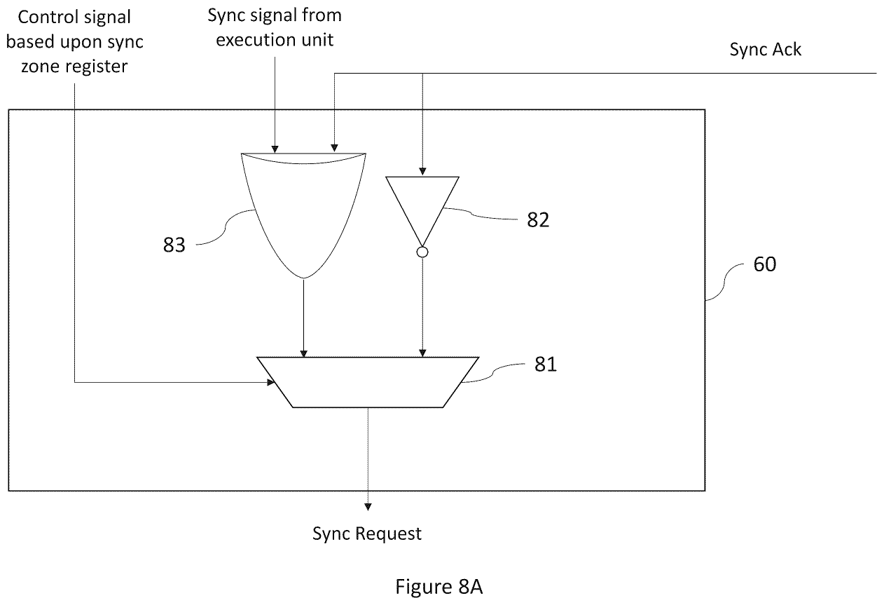

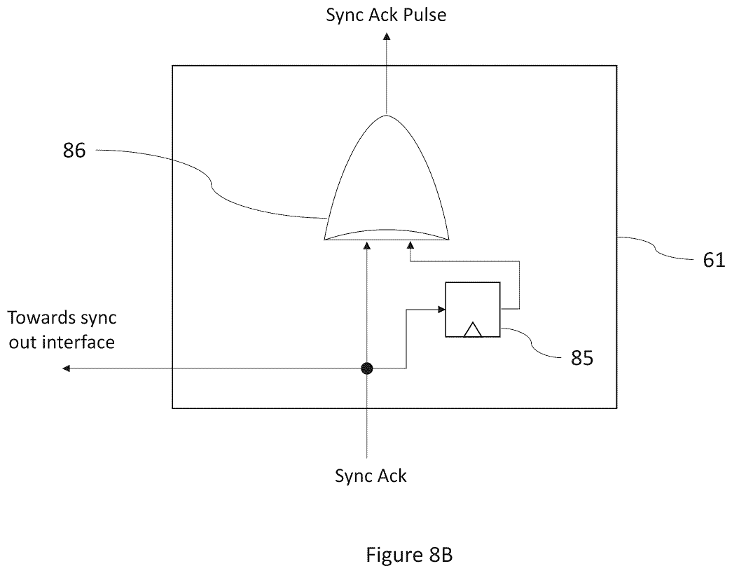

Reference is made to FIG. 8A, which illustrates an example of a sync output interface 60. The sync output interface 60 comprises an inverter 82 configured to invert the internal sync acknowledgment signal, so as to provide a signal that may be output to provide a tile sync request when the tile 4 is not participating in the sync zone associated with the interface 60. The sync output interface 60 comprises a multiplexer 81, which is controlled in dependence upon the indication in the register 53 to select between outputting the inverted form of the internal sync acknowledgment supplied by the inverter 82 or outputting a sync signal controlled by the execution of SYNC instructions by the execution unit 52.

If the tile 4 does not participate in the sync zone associated with the interface 60 shown in FIG. 8A, a control signal reflecting the indication in register 53 that the tile 4 does not participate is received at multiplexer 81 and controls multiplexer 81 to select the inverted form of the internal sync acknowledgment. The interface 60 outputs this inverted form of the internal sync acknowledgment on the sync request wire. Since the inverted form of the internal sync acknowledgment reflects an asserted tile sync request, in this way, when the tile 4 is not participating in the sync zone, the tile sync request for the sync zone is continually asserted, irrespective of the activity of the execution unit 52.

If the tile 4 does participate in the sync zone associated with the interface 60 shown in FIG. 8A, a control signal reflecting the indication in register 53 that the tile 4 does participate is received at the multiplexer 81 and controls multiplexer 81 such that the state of the sync request wire is controlled by the execution unit 52. This execution unit 52 provides a sync signal, and sets this sync signal to high in order to assert a tile sync request and sets the sync signal to low in order to deassert a sync request. The XOR gate 83 is used to provide the tile sync request according to the signalling scheme for signalling sync requests to the sync controller 55. The XOR gate 83 receives the internal sync ack signal and either outputs this sync ack, in the case that the execution unit 52 is not asserting the sync control signal, or outputs an inverted form of the internal sync ack, in the case that the execution unit is asserting the sync control signal. In this way, when the multiplexer 81 is controlled to select the output from the XOR gate 83, the multiplexer 81, and hence the output interface 60, outputs a tile sync request when controlled to do so by the execution unit 52. To issue a tile sync request, the execution unit 52 executes SYNC instructions, which cause the state of the sync request wire output from interface 60 to be set to be the opposite to the current state of the sync acknowledgment wire.

Reference is made to FIG. 8B, which illustrates an example of a sync input interface 61, which receives the internal sync acknowledgement signal and in dependence upon the state of this signal, outputs sync ack pulses to the execution unit 52. The example sync input interface 61 may be associated with any of the sync zones, and each of the sync input interfaces 61 for the different sync zones comprises the same circuitry. The example sync input interface 61 may be associated with the same sync zone as the example sync output interface 60 that is illustrated in FIG. 8A.

The interface 61 comprises a flip flop 85, which stores the state of the internal sync ack signal received at the interface 61. The flip flop 85 outputs this latched state. The interface 61 also comprises an XOR gate 86, which receives the state of the sync ack wire as one input and receives the output of the flip flop 85 as another input. The XOR gate 86 outputs a high signal when these two inputs differ. When the state of the sync ack wire for interface 61 changes, the state of this sync ack wire will temporarily not match the output of the flip flop 85. As a result, the XOR gate 86 receives one high input, and one low input, and as a consequence outputs a high signal. When, after one clock cycle, the state of the flip flop 85 is updated to match the updated state of the sync ack wire, the output of the flip flop 85 will then match the state of the sync ack wire. As a consequence, the XOR gate 86 then outputs a low signal. In this way, the interface 61 provides a pulse (the sync ack pulse) in response to an edge in its received sync ack signal. The sync ack pulse is output from the interface 61 to the execution unit 52. If the execution unit 52, has executed a SYNC instruction for the sync zone corresponding to the sync ack pulse, it stalls whilst waiting for this sync ack pulse. In response to receipt of the sync ack pulse, the execution unit 52 passes the barrier and proceeds to the exchange phase in which data is exchanged between its tile 4 and the other tiles 4. If the execution unit 52 has not executed such a SYNC instruction, but is part of a tile 4 that is indicated in the sync zone register 53 as not participating in the sync zone associated with the sync ack pulse, the execution unit 52 ignores the sync ack pulse.

As is also shown in FIG. 8B, the internal sync ack signal that is received at the interface 61 is also provided to the corresponding sync output interface 60 that is associated with the sync input interface 61. As shown in FIG. 8A, this internal sync ack signal is provided as an input both to the XOR gate 83 and to the inverter 82 and is, in this way, used to provide the tile sync request signal.

Each of the tiles 4 in the processing unit 2a operates similarly to assert tile sync requests in dependence upon the state of its sync acknowledgment wires. Aggregation circuitry is provided in the processing unit 2a for aggregating the tile sync requests output by the tiles 4 to provide an internal sync request that is provided to the sync controller 55. The aggregation circuitry performs such aggregation for each sync zone to provide an aggregate sync request state for each sync zone. The aggregation circuitry is configured to aggregate the state of the tile sync request outputs such that the aggregate signal changes state in response to the tile sync request state of each tile 4 changing state. For example, if the state of each tile's 4 sync request wire for a particular sync zone in the processing unit 2 is set to a low state, the aggregate signal will also be low. The aggregation circuitry causes the aggregate signal to change state to a high state in response to the state of all of the tile sync request wires for the sync zone being set to a high state.

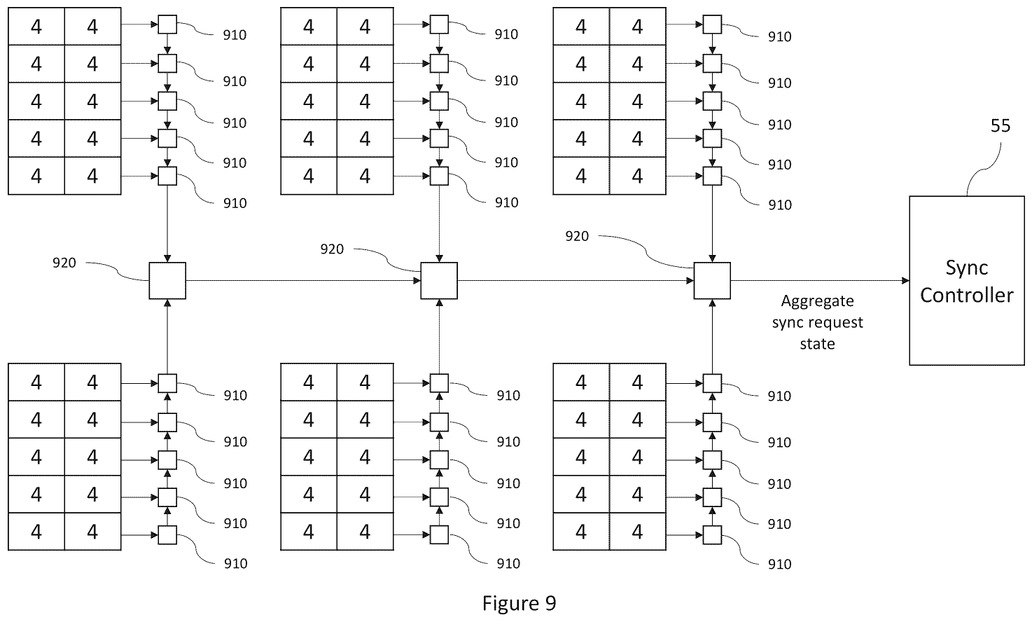

Reference is made to FIG. 9, which illustrates an example as to how the tile sync requests are aggregated across the processing unit 2a. As shown, the tiles 4 are arranged in pairs (referred to as ‘pair tiles’), with the pairs being arranged in columns. The aggregation circuitry comprises sets of circuitry 910 and circuitry 920. Each of the pair tiles is associated with a set of circuitry 910 that is configured to aggregate the sync request state from its associated tiles 4. Each set of circuitry 910 receives sync request state from upstream in the sync network and aggregates this state with the sync request state output by the associated pair tiles 4. Between the columns, circuitry 920 is configured to receive the aggregated sync request state from the different ones of the columns.

As will be described, the aggregation circuitry 910, 920 is configured to perform the aggregation of sync request state in dependence upon the state of the internal sync acknowledgment signal (which is output by the sync controller 55) for the sync zone.

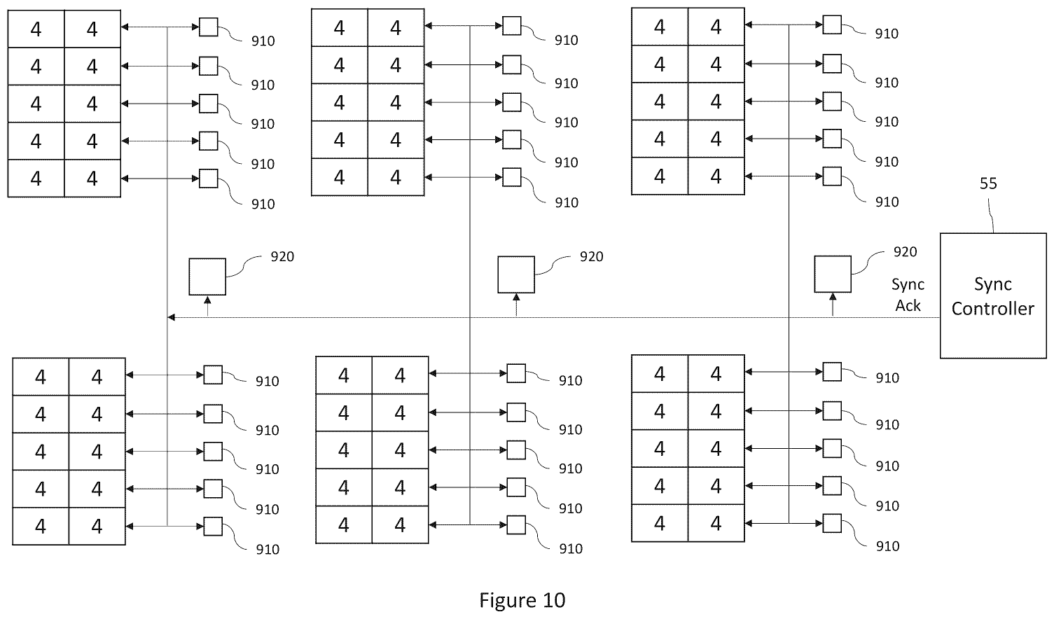

Reference is made to FIG. 10, which illustrates how an internal sync acknowledgment may be distributed to different tiles 4 of the processing unit 2a and to the aggregation circuitry 910, 920. As will be described in more detail, the sync controller 55 changes the state of the internal sync acknowledgment signal in response to receipt of an internal sync request.

As shown, the internal sync acknowledgement signal is provided to all of the tiles 4, the aggregation circuitry 910 and the aggregation circuitry 920. The internal sync acknowledgment signal output by the sync controller 55 is provided with the same state on all of the sync acknowledgment wires used to distribute the signal to the tiles 4 and the circuitry 910, 920.

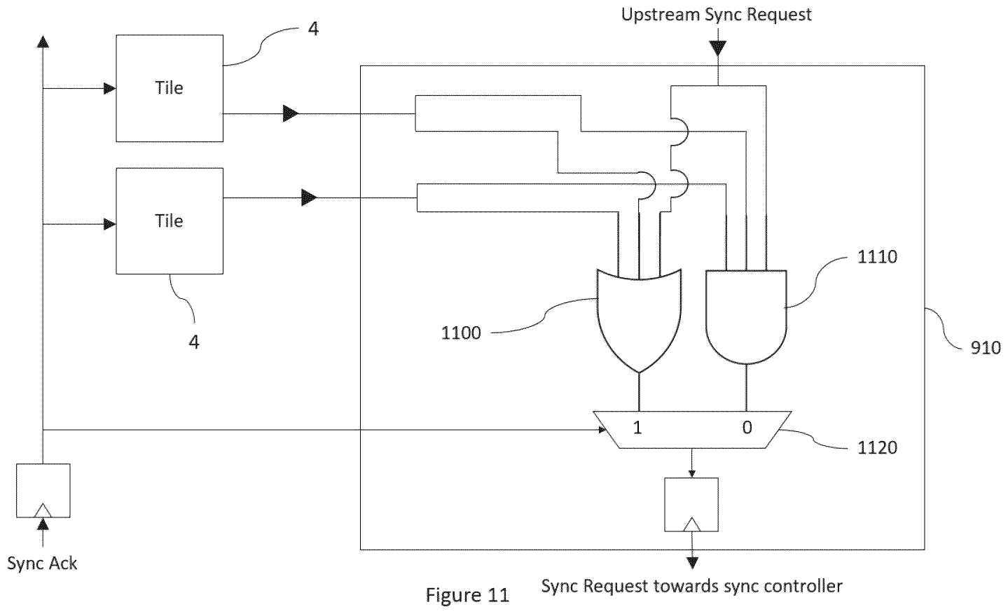

Reference is made to FIG. 11, which illustrates an example of aggregation circuitry 910 according to example embodiments. The aggregation circuitry 910 comprises an OR gate 1100, and an AND gate 1110. Each of the gates 1100, 1110 receives sync request state from each of the two pair tiles 4 associated with circuitry 910. Each of the gates 1100, 1110 additionally receives an upstream sync request signal, which reflects aggregated sync request state for tiles 4 further up the relevant column.

The circuitry 910 comprises a multiplexer 1120, which is controlled in dependence upon the internal sync acknowledgment signal to select between the output of the OR gate 1100 and the output of the AND gate 1110. If the internal sync acknowledgment signal is high, the OR gate 1100 is selected, whereas if the internal sync acknowledgment signal is low, the AND gate 1110 is selected. The consequence of this selection is that the circuitry 910 only outputs a signal that is opposite to the internal sync acknowledgment signal if all of the tile sync request signals (i.e. the signals from both tiles 4 and the upstream sync request signal) received at circuitry 910 have the opposite state to the internal sync acknowledgment signal. For instance, if the internal sync acknowledgment signal is high, the OR gate 1100 is selected, and so the tile sync request state output by circuitry 910 will also be high unless all inputs to the OR gate 1100 are low. On the other hand, if the internal sync acknowledgment signal is low, the AND gate 1110 is selected, and so the tile sync request state output by circuitry 910 will also be low, unless all inputs to the AND gate 1110 are high.

Multiple instances of circuitry 910 are chained together to provide aggregate sync request state for a column.

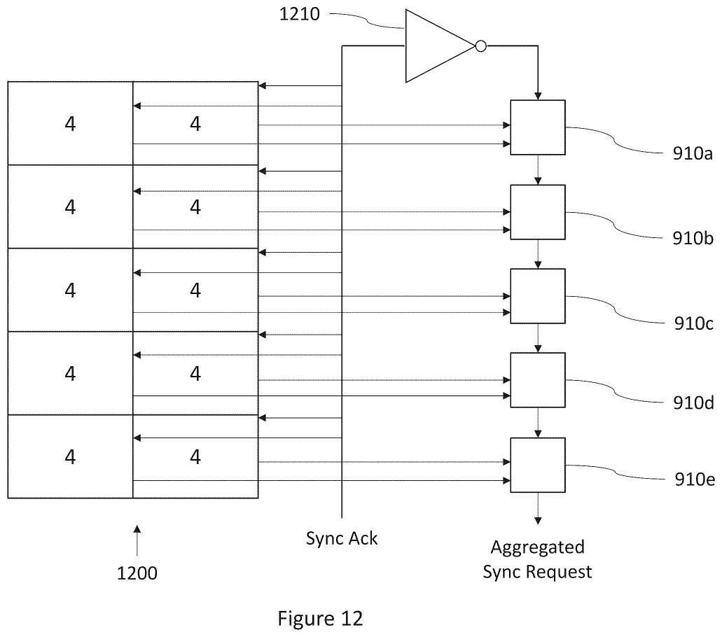

Reference is made to FIG. 12, which illustrates how the aggregate sync request state may be provided for a column 1200 of tiles 4. Each of the sets of circuitry 910b-e is configured to, as shown in FIG. 11, receive the tile sync request state output by its associated tiles 4, and additionally receive the aggregate sync request state (also referred to as the upstream sync request state) provided by the adjacent set of circuitry 910. For example, circuitry 910b receives the upstream sync request state output by circuitry 910a, circuitry 910c receives the upstream sync request state output by circuitry 910b, and so on. Since circuitry 910a is located at the top of the column 1200, with no further aggregation circuitry 910 located above, the circuitry 910a receives as its upstream sync request state, the output of invertor 1210. The invertor 1210 inverts the sync acknowledgment signal and in so doing provides as its output, an asserted sync request signal. Each of the sets of circuitry 910a-e will output an asserted sync request once it receives an asserted tile sync request from its associated tiles 4 and an asserted sync request from higher in the column 1200. In this way, once all of the tiles 4 also provide an asserted sync request signal, the aggregate output by the circuitry 910e will also be the same asserted sync request signal.

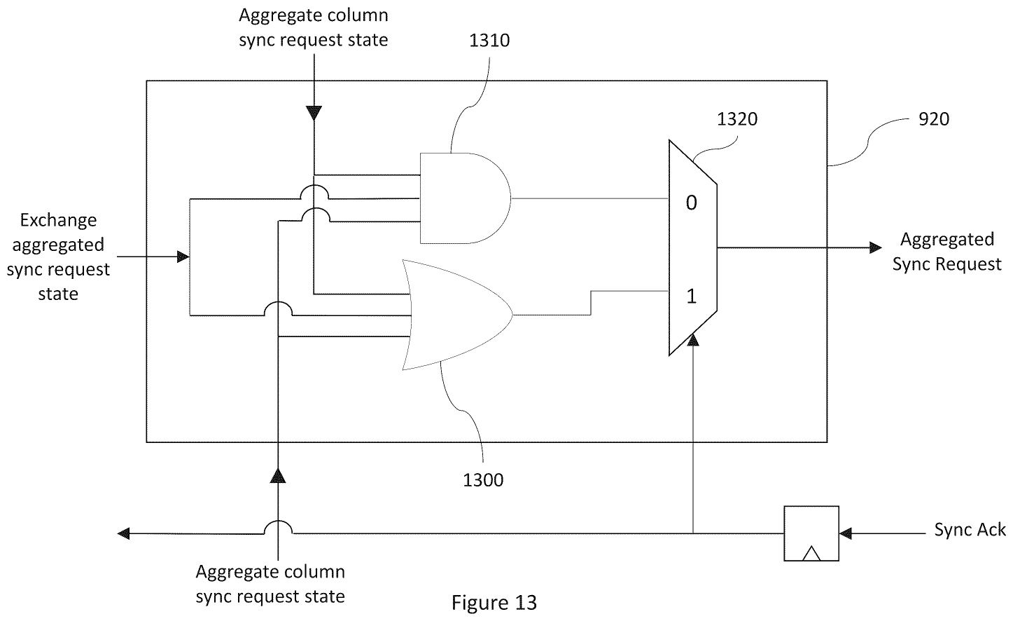

Reference is made to FIG. 13, which illustrates an example of the aggregation circuitry 920, and shows how the circuitry 920 aggregates the sync request state of different columns. As with the circuitry 910, the circuitry 920 includes an OR gate 1300 and an AND gate 1310. Both the AND gate 1310 and the OR gate 1300 receive as inputs, the aggregated sync request state from two of the columns, and further aggregated sync request state. The further aggregated sync request state is shown in FIG. 13 as “Exchange aggregated sync request state” since the state is aggregated in the direction of the data exchange wiring, which runs perpendicular to the columns. The exchange aggregated sync request state may be output by a further instance of the circuitry 920 that is upstream in the sync network or, if there are no further instances of the circuitry 920 that are upstream, may be provided by an inverted form of the internal sync acknowledgment signal.

The circuitry 920 comprises a multiplexer 1320, which is controlled in dependence upon the internal sync acknowledgment signal to select between the output of the OR gate 1300 and the output of the AND gate 1310. If the internal sync acknowledgment signal is high, the OR gate 1300 is selected, whereas if the internal sync acknowledgment signal is low, the AND gate 1310 is selected. The consequence of this selection is that the circuitry 920 only outputs a signal that is opposite to the internal sync acknowledgment signal if all of the aggregate sync request state (i.e. the aggregate sync request state from both associated columns and the exchange aggregated sync request state) received at circuitry 920 have the opposite state to the internal sync acknowledgment signal. For instance, if the internal sync acknowledgment signal is high, the OR gate 1300 is selected, and so the aggregate sync request state output by circuitry 920 will also be high unless all inputs to the OR gate 1300 are low. On the other hand, if the internal sync acknowledgment signal is low, the AND gate 1310 is selected, and so the aggregate sync request state output by circuitry 920 will also be low, unless all inputs to the AND gate 1310 are high.

Multiple instances of circuitry 920 are chained together to provide aggregate sync request state for the processing unit 2a. The consequence of the aggregation performed by the instances of the circuitry 910 and the instances of the circuitry 920 is that the aggregate sync request state that is provided represents an internal sync request when all of the tiles 4 have set their sync request output signal appropriately.

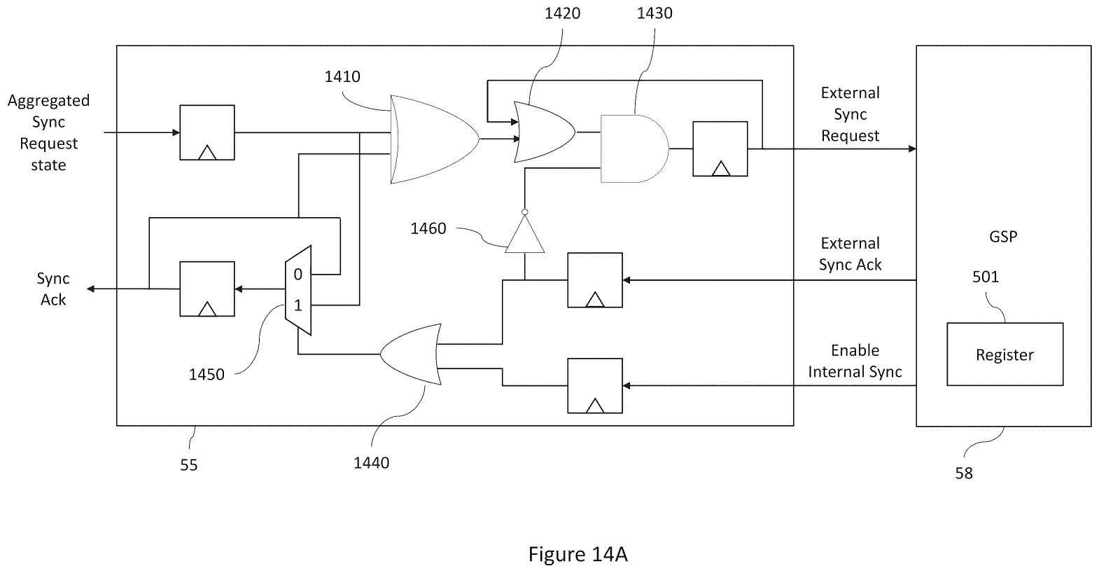

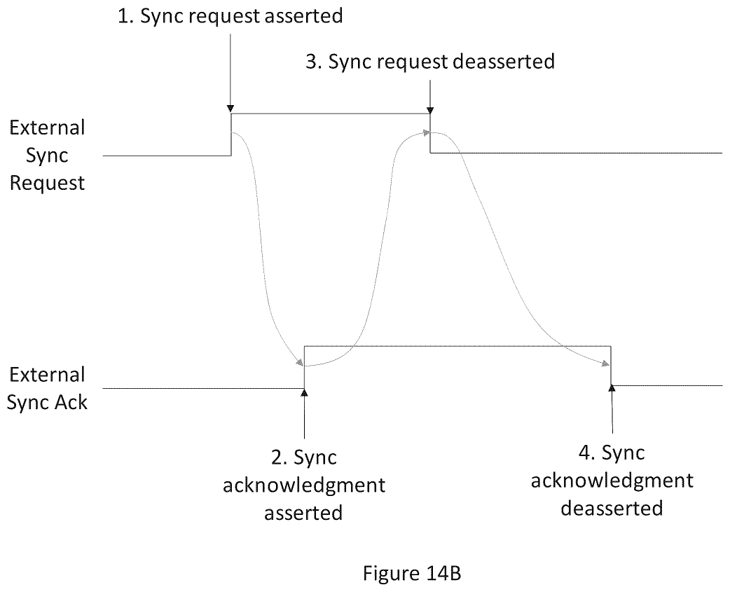

Reference is made to FIG. 14A, which illustrates circuitry within the sync controller 55. FIG. 14A shows the circuitry provided in sync controller 55 that is associated with a single sync zone. However, it would be appreciated that sync controller 55 comprises a separate instance of such circuitry for each sync zone. The circuitry within the sync controller 55 provides an internal sync ack in response to receipt of an internal sync request. The circuitry of the sync controller 55 also communicates with the GSP 58 to send and receive external sync request and acknowledgment signals. The external sync request and acknowledgment signals are provided according to an alternative sync signalling scheme, which is described in more detail with reference to FIG. 14B.

A register 501 is provided in the GSP 58 and indicates for each of the sync zones supported for the processing unit 2a, which of those zones is configured as being internal (including only tiles 4 of the processing unit 2a) and which is configured as being external (also including tiles 4 of other processing units 2).

If the sync zone for which circuitry is shown in FIG. 14A is configured as internal, a signal indicating as such (shown as the ‘enable internal sync’ signal) is provided by circuitry of the GSP 58 to the OR gate 1440. Consequently, the OR gate 1440 outputs a high signal to the multiplexer 1450. The signal is used to control the multiplexer 1450 to output the internal sync request state (i.e. the aggregate sync request state received at the controller 55). The internal sync ack state is consequently set to be the same as the internal sync request state. In this way, when the sync zone is configured to be internal, the sync controller 55 immediately acknowledges the internal sync request by setting the internal sync acknowledgment state to be the same as the internal sync request state.

If the sync zone for which circuitry is shown in FIG. 14A is configured as external, the enable internal sync signal is set low and, therefore, the output of the OR gate 1440 will be set to be low until the GSP 58 provides an external sync acknowledgment signal. Before the external sync acknowledgment is received from the GSP 58, the sync controller 55 provides an external sync request to the GSP 58.

The external sync requests and sync acknowledgments are represented according to a different sync scheme to the scheme (exemplified in FIG. 7) that is used for the tile sync requests and acknowledgments and for the internal sync request and acknowledgments. Reference is made to FIG. 14B, which illustrates the scheme for signalling external sync requests and acknowledgments. This Figure illustrates an example of a sync handshake between a downstream propagation node and an upstream propagation node in the sync network. The downstream propagation node may, for example, be the GSP 58 on one chip 500, whilst the upstream propagation node is the GSP 58 on another chip 500.

FIG. 14B illustrates the state of an external sync request signal and the state of an external sync acknowledgment signal. These are each provided on separate wires and so the state of the signals reflect the state of the wires. At the start of the sync handshake, the downstream propagation node provides an external sync request (shown as 1. sync request asserted) by setting the external sync request signal to be high. This causes an external sync request to be detected at the upstream propagation node. The downstream propagation node will keep the external sync request asserted until it receives an external sync acknowledgment. In effect, the downstream propagation node stalls until it receives the external sync acknowledgment. The upstream propagation node, in response to the external sync request, provides an external sync acknowledgment (shown as 2. sync acknowledgment asserted) by setting the external sync acknowledgment signal to be high. This causes an external sync acknowledgment to be detected at the downstream propagation node. The downstream propagation node, in response to the external sync acknowledgment, deasserts the external sync request (shown as 3. sync request deasserted) by setting the external sync request signal low. The upstream propagation node detects that the sync request signal has been deasserted and, in response to the deassertion of the sync request signal, deasserts the external sync acknowledgment (shown as 4. sync acknowledgment deasserted) by setting the state of the external sync acknowledgment signal to be low. With the external sync acknowledgment signal deasserted, the sync handshake between the two nodes of the sync network is then complete.

The sync controller 55 comprises circuitry for converting an internal sync request to an external sync request and for converting the external sync acknowledgment to an internal sync acknowledgement. The circuitry comprises a XOR gate 1410, which is part of the circuitry for generating the external sync request from an internal sync request. The XOR gate 1410 receives as one input, the aggregate sync request state of the processing unit 2a, and as another input, the current state of the internal sync ack signal. The XOR gate 1410 outputs a high signal (indicating a sync request) if there is a mismatch between this aggregate sync request state and the sync ack state. Such a mismatch is indictive that a tile sync request has been asserted by all of the tiles 4 of the processing unit 2a. When a high signal is output from the XOR gate 1410, this is provided to the OR gate 1420, which responds by also issuing a high signal, which is provided to the AND gate 1430. The AND gate 1430 receives as one input, the output of OR gate 1420, and as another input the inverted state of the external sync acknowledgment signal. The AND gate 1430, therefore, only outputs a high signal if the external sync acknowledgment signal is currently low (indicating that the external sync acknowledgment is not currently asserted). The output of the AND gate 1430 provides the external sync request signal to the GSP 58.

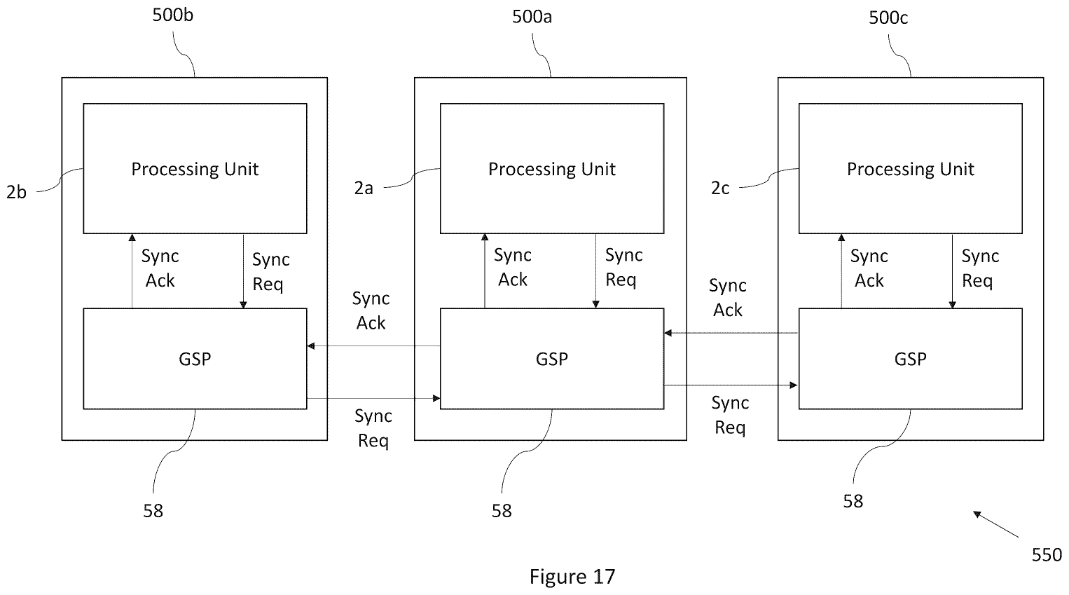

As described in more detail with respect to FIG. 17 below, the GSP 58 is configured to exchange external sync requests and acknowledgments with additional GSPs 58 in the system 550. Following this process, the GSP 58 provides the external sync ack signal, which is provided to invertor 1460 and the OR gate 1440. The invertor 1460 inverts the external sync ack signal (which is now set high) to produce a low signal, which is provided to the AND gate 1430. In response, the AND gate 1430 outputs a low signal, causing the external sync request to be deasserted. The OR gate 1440 provides a high output to the multiplexer 1450. This signal is used to control the multiplexer 1450 such that the internal sync request state is output from the multiplexer 1450. Therefore, in response to the external sync ack signal, the multiplexer 1450 is controlled to set the internal sync ack state to be the same as the internal sync request state, thus causing an internal sync acknowledgement to be sent to the tiles 4.

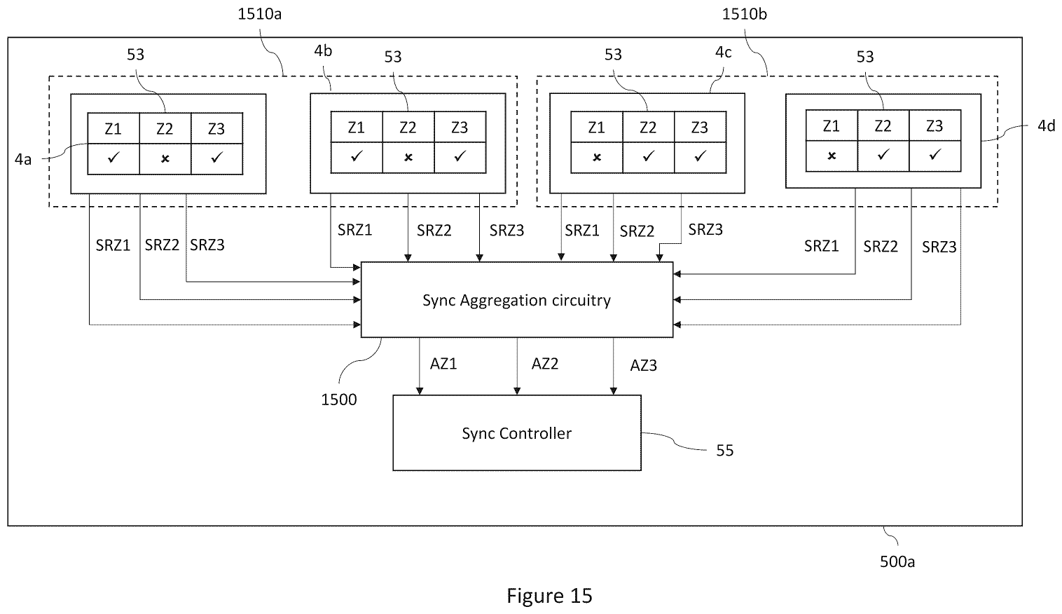

Reference is made to FIG. 15, which illustrates how different groupings of tiles 4 may be subscribed to three different sync zones. FIG. 15 shows the indications in each of registers 53 for these three sync zones. As shown, the registers 53 for tile 4a and tile 4b belong to a first sync zone (labelled as ‘Z1’) and to a third sync zone (labelled as ‘Z3’), but do not belong to a second sync zone (labelled as ‘Z2’). Also, as shown, the registers 53 for tile 4c and 4d belong to the second sync zone (labelled as ‘Z2’) and to the third sync zone (labelled as ‘Z3’), but do not belong to a first sync zone (labelled as ‘Z1’). The sync aggregation circuitry 1500 shown in FIG. 15 may comprise the aggregation circuitry 910 and 920 discussed above.

Although in practice, more than two tiles 4 of the processing unit 2 would likely participate in each sync zone, in FIG. 15, Z1 is shown as including a group 1510a of two tiles 4a, 4b and Z2 is shown as including a group 1510b of two tiles 4c, 4d.

Since tiles 4c and 4d do not belong to Z1, these tiles 4c, 4d continually assert a tile sync request on their sync request wires associated with Z1. These sync requests are shown in FIG. 15 as SRZ1. As discussed above, in embodiments, the assertion of a tile sync request is represented by setting the state of the relevant sync request wire to be opposite to the state of the relevant sync acknowledgment wire.

Since tiles 4a and 4b do belong to Z1, these tiles 4a, 4b only assert a tile sync request on their sync request wire for Z1 when they reach a barrier synchronisation that is associated with Z1 in their compiled code set. At this point, the execution unit 52 of the respective tile 4a, 4b executes a SYNC instruction taking an indication of Z1 as an operand, which causes a tile sync request to be asserted on the sync request wire of the tile 4 that is associated with Z1.

Once the tiles 4a, 4b belonging to Z1 have reached the barrier synchronisation, all of the tiles 4 (including those not belonging to Z1) in the processing unit 2a are asserting a tile sync request for Z1. The sync aggregation circuitry 1500 aggregates the tile sync requests to provide the internal sync request (shown as AZ1) for Z1 to the sync controller 55.

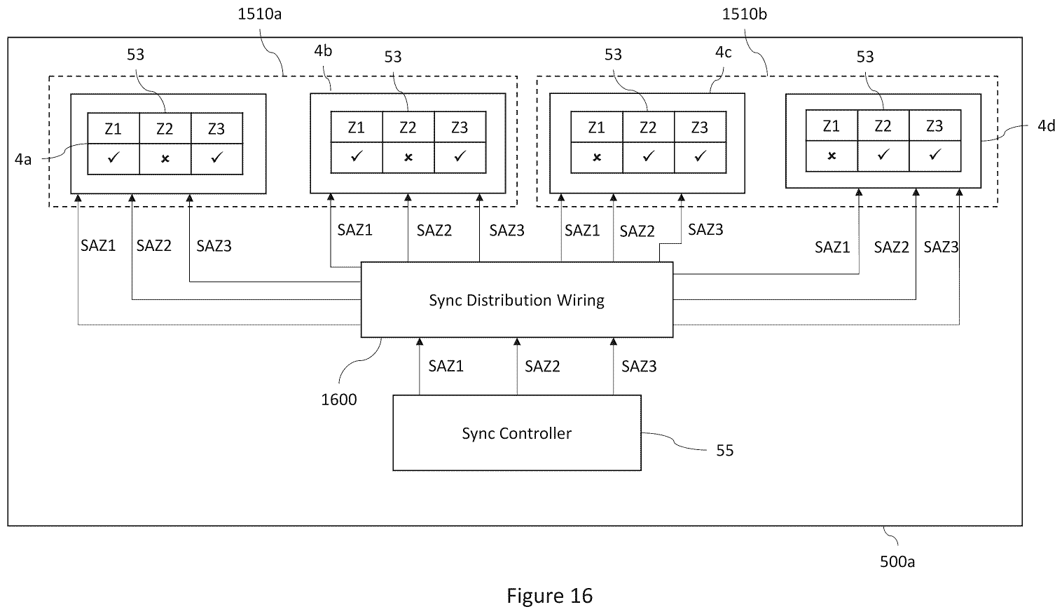

Reference is made to FIG. 16, which illustrates how internal sync acknowledgments are returned to the tiles 4. The sync distribution wiring shown in FIG. 16 may comprise the wiring shown in FIG. 10 for providing internal sync acknowledgments to the tiles 4. In response to the receipt of AZ1, the sync controller 55 asserts an internal sync acknowledgment signal (shown as SAZ1) that is associated with Z1. SAZ1 is provided by sync distribution wiring 1600 to each of the tiles 4a-d. In response to receipt of this internal sync acknowledgment signal, the execution units 52 of tiles 4a,4b pass the barrier synchronisation and proceed to the exchange phase. If the exchange phase is an internal exchange phase, one or more of the execution units 52 of tiles 4a, 4b execute instructions to exchange data between tiles 4a, 4b. If the exchange phase is an external exchange phase, one or more of the execution units 52 of tiles 4a, 4b execute instructions to exchange data with devices external to the device 500a.

When SRZ1 is received at the tiles 4c, 4d not belonging to Z1, the execution units 52 of these tiles 4c, 4d take no action in response to SRZ1 and continue to operate asynchronously to the compute and exchange cycle for Z1.

Referring back to FIG. 15, the situation with Z2 is considered. Since tiles 4a and 4b do not belong to Z2, these tiles 4a, 4b continually assert a tile sync request on their sync request wire associated with Z2. This sync request is shown in FIG. 15 as SRZ2.

Since tiles 4c and 4d do belong to Z2, these tiles 4a, 4b only assert a tile sync request on their sync request wire for Z2 when they reach a barrier synchronisation that is associated with Z2 in their compiled code set. At this point, the execution units 52 of the tiles 4c, 4d each execute a SYNC instruction taking an indication of Z2 as an operand. Each such SYNC instruction causes the logic in the respective tile 4 to assert an internal sync request on its sync request wire for Z2.

Once the tiles 4c, 4d belonging to Z2 have reached the barrier synchronisation, all of the tiles 4 (including those not belonging to Z2) in the processing unit 2a are asserting a tile sync request for Z2. The sync aggregation circuitry 1500 provides the aggregated sync request (shown as AZ2) for Z2 to the sync controller 55.

Reference is again made to FIG. 16, which illustrates how sync acknowledgments for the Z2 sync are returned to the tiles 4. In response to receipt of AZ2, the sync controller 55 asserts an internal sync acknowledgment signal (shown as SAZ2) that is associated with Z2. SAZ2 is provided by sync distribution wiring 1600 to each of the tiles 4a-d. In response to receipt of this sync acknowledgment signal, the execution units 52 of tiles 4c,4d pass the barrier synchronisation and proceed to the exchange phase. If the exchange phase is an internal exchange phase, one or more of the execution units 52 of tiles 4c,4d execute instructions to exchange data between tiles 4c,4d. If the exchange phase is an external exchange phase, one or more of the execution units 52 of tiles 4c,4d execute instructions to exchange data with devices external to the device 500a.

Referring back to FIG. 15, the situation with Z3 is considered. As shown, in each of the tiles 4a-d of the processing unit 2a, the respective register 53 indicates that the tile 4 belongs to Z3. As a result, each of the tiles 4a-d issues a tile sync request when it reaches a barrier synchronisation associated with Z3. Upon reaching this barrier, the execution unit 52 of each tile 4 executes a SYNC instruction taking an indication of Z3 as an operand, thus causing a tile sync request to be issued on the sync request wire of the respective tile 4. The sync aggregation circuitry 1500 aggregates the state of the sync request wires and provides an internal sync request (AZ3) to the sync controller 55. As shown in FIG. 16, in response to receipt of AZ3, the sync controller 55 causes an internal sync acknowledgment to be returned to each of the tiles 4a-d in the processing unit 2a. The sync distribution wiring 1600 causes the internal sync acknowledgment signal to be asserted on the sync acknowledgment wires associated with Z3. Since all of these tiles 4a-d belong to Z3, in response to the internal sync acknowledgment, the execution unit 52 of each tile 4a-d passes the barrier synchronisation and enters the exchange phase (which may be an internal or an external exchange phase).

As noted above, the sync controller 55 will, if the sync zone for which an internal sync request is received is configured as an internal sync zone, acknowledge the sync request without providing an external sync request to the GSP 58. However, if the sync zone is configured as an external sync zone, the sync controller 55 will forward the external sync request to the GSP 58 and await receipt of an external sync acknowledgment from the GSP 58 before forwarding the internal sync acknowledgment to the tiles 4. The GSP 58 itself contains different configuration settings that indicate how external sync requests should be propagate for different external sync zones.

To illustrate the concept of a sync network comprising sync master nodes, sync propagation nodes, and slave nodes, reference is made to FIG. 19, which illustrates an example sync network 700 for a sync zone. The sync network 700 includes a sync master 710 and multiple sync propagation nodes 720a, 720b, 720c. In example embodiments, each of the sync master 710 and the sync propagation nodes 720a, 720b, 720c is a GSP 58. The sync network 700 further comprises a plurality of sets of slave nodes 730a, 730b, 730c, 730d from which sync requests originate. The slave nodes 730a, 730b, 730c, 730d together form a sync group defined for the sync network 700. In the embodiments described herein, the tiles 4 function as the slave nodes for a barrier sync, and the sync requests which originate from those slave nodes are the tile sync requests discussed above. The slave nodes are divided into different sets. For example, there is a first set of slave nodes 730a, a second set of slave nodes 730b, a third set of slave nodes 730c, and a fourth set of slave nodes 730d. In these embodiments, each of the sets of slave nodes 730a, 730b, 730c, 730d are tiles 4 of a different processing unit 2a. Each slave nodes issues a sync request upstream in the sync network 700. The sync requests from a group of slave nodes are aggregated and provided to a node higher in the sync network.

As shown in FIG. 19, each of the sync master 710 and the sync propagation nodes 720a, 720b, 720c has an associated downstream set of slave nodes from which it receives an aggregated sync request for each barrier sync. For example, sync propagation node 720a is associated with the first set of slave nodes 730a. In embodiments in which the sync master 710 and sync propagation nodes 720a, 720b, 720c are GSPs 58, each of the sets of slave nodes are tiles 4 on the same chip 500 as their associated GSP 58.

Sync propagation nodes 720b, 720c receive aggregated sync requests originating from their associated slave nodes 730b, 730c, but do not receive sync requests from other sync propagation nodes. In response to receipt of a sync request originating from its associated slave nodes 730b, 730c, each sync propagation node 720b, 720c propagates a sync request upstream in the sync network 700 to sync propagation node 720a.

Sync propagation node 720a waits until it receives a sync request from each of its downstream nodes. These downstream nodes comprise the sync propagation nodes 720b, 720c and the set of slave nodes 730a associated with sync propagation node 720a. When sync propagation node 720a has received all of the sync requests from each of its downstream nodes, it issues a sync request to the sync master 710.

The sync master 710 waits until it receives a sync request from each of its downstream nodes. These downstream nodes comprise the sync propagation node 720a and the set of slave nodes 730d associated with the sync master 710. When the sync master 710 has received all of the sync requests from each of its downstream nodes, it issues sync acknowledgments back to the sync propagation node 720a and to the slave nodes 730d.

The sync propagation node 720a, upon receiving a sync acknowledgment from the sync master 710, issues sync acknowledgments to each of the downstream sync propagation nodes 720b, 720c and to its associated slave nodes 730a. Likewise, the sync propagation nodes 720b, 720c, in response to receipt of these sync acknowledgments, each issue sync acknowledgments to their associated slave nodes 730b, 730c. All of the slave nodes 730a-d of the sync network 700, in response to receipt of the sync acknowledgments, pass the barrier synchronisation and exchange data during the exchange phase.

The example in FIG. 19 shows a specific arrangement of a sync network 700 in which the sync master 710 receives a sync request from only one downstream sync propagation node 720a. However, in other examples, the sync master 710 may receive sync requests from more than one downstream sync propagation node. Similarly, although the example sync propagation node 720a receives sync requests from two downstream sync propagation nodes 720b, 720c, alternatively it may receive sync requests from a different number of downstream sync propagation nodes.

Reference is made to FIG. 17, which illustrates a system 550 comprising a plurality of devices 500a-c. FIG. 17 shows how the GSPs 58 of these devices 500a-c exchange external sync requests and external sync acknowledgments at an external barrier synchronisation.

Each processing unit 2a-c issues an external sync request to its associated GSP 58. Such an external sync request is issued by the sync controller 55 of the processing unit 2 when that sync controller 55 receives aggregate sync request state (i.e. an internal sync request) indicating that each of the tiles 4 of its processing unit 2 has issued a tile sync request. Each of the internal sync requests shown in FIG. 17 as being sent by the sync controller 55 to the GSP 58 is associated with the same sync zone.

Each GSP 58 stores configuration settings for different sync zones indicating how it will respond to received external sync requests from those zones. These configuration settings indicate which interfaces of the GSP 58 are enabled for particular sync zones and the directionality (i.e. whether sync requests are sent or received on those interfaces) for the enabled interfaces. In the example of FIG. 17, the GSP 58 of device 500b is configured to, in response to receipt of the external sync request from the sync controller 55 of processing unit 2b, propagate the external sync request upstream to GSP 58 of device 500a. The GSP 58 of device 500a is configured to, in response to receipt of both the external sync request from the sync controller 55 of processing unit 2a and the external sync request from the GSP 58 of device 500b, propagate an external sync request upstream to GSP 58 of device 500c. The GSPs 58 of devices 500a and 500b, therefore, both acts as intermediate nodes (i.e. propagation nodes) in the sync network. The GSP 58 of device 500c is configured to receive the external sync request from GSP 58 of device 500a and an external sync request from the sync controller 55 of device 500c. In response to receipt of these external sync requests, the GSP 58 of device 500c issues an external sync acknowledgment to the sync controller of device 500c and an external sync acknowledgment to the GSP 58 of device 500a. The GSP 58 of device 500c, therefore, acts as the master node for the sync network. In response to receipt of the external sync acknowledgment, the GSP 58 of device 500a issues external sync acknowledgments to the sync controller 55 of device 500a and to the GSP 58 of device 500b. In response to receipt of the external sync acknowledgment from the GSP 58 of device 500a, the GSP 58 of device 500b issues an external sync acknowledgement to the sync controller 55 of device 500b. Each of the sync controllers 55 of the devices 500a-c, in response to receipt of the respective sync acknowledgments, issues sync acknowledgment to all of the tiles 4 of its respective processing unit 2-c, as described above with respect to FIG. 14A. The tiles 4 belonging to the sync zone (as indicated in their sync zone register 53), in response to receipt of such external sync acknowledgments, proceed to the external exchange phase.

The sync zone for which the external sync requests and external sync acknowledgments shown in FIG. 17 are exchanged may be sync zone Z3 that was discussed above with reference to FIGS. 15 and 16.

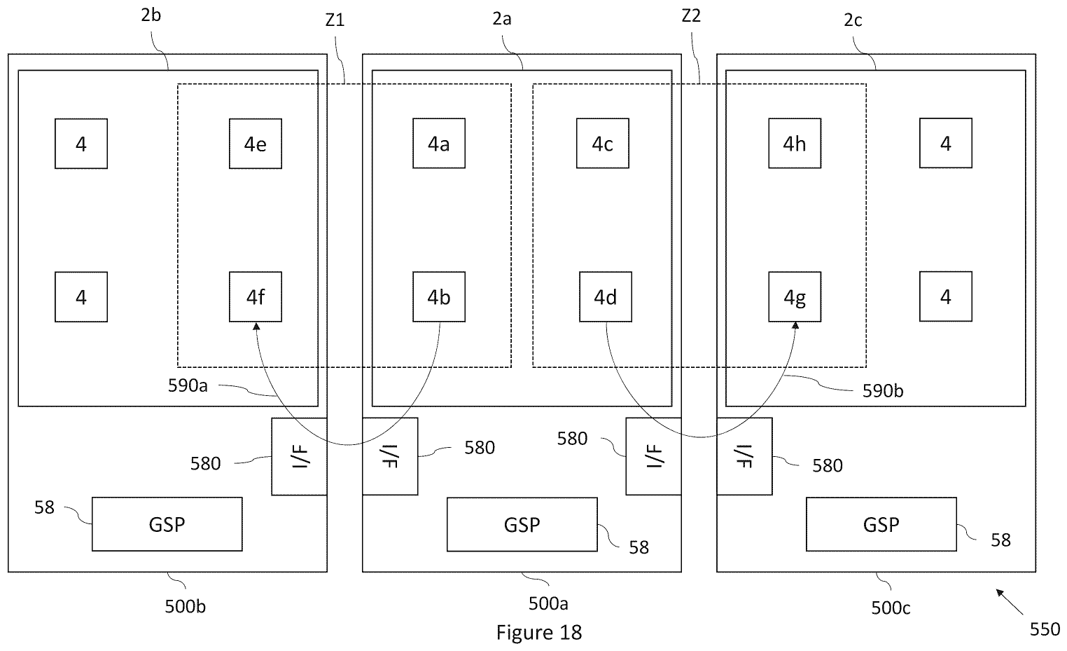

Reference is made to FIG. 18, which illustrates how data exchange may be performed between different processing units 2 during external exchange phases for sync zones Z1 and Z2. In this example, sync zone Z1 that was discussed above with reference to FIGS. 15 and 16 comprises, in addition to tiles 4a and 4b, tiles 4e and 4f, which belong to processing unit 2b. The registers 53 of tiles 4e and 4f comprise indications that these tiles belong to sync zone Z1. Tiles 4a and 4b, when they reach the barrier synchronisation for Z1, each issue an external sync request toward the sync controller 55 of device 500a in the manner described above with respect to FIG. 15. In the same manner, tiles 4e and 4f when they reach the barrier synchronisation for Z1, each issue a tile sync request towards the sync controller 55 of device 500b. In response, these sync controllers 55 each forward an external sync request to the GSP 58 of their device 500a, 500b. In the manner described above with reference to FIG. 17, the GSPs 58 of the devices 500a, 500b exchange an external sync request and an external sync acknowledgement and then cause internal sync acknowledgments to be sent (via the sync controller 55 of their device 500a,b) to the tiles 4a,b,e,f of the device 500a, 500b to which they belong. Data exchange then takes place between one or more of tiles 4a,b and one or more of tiles 4e,f via interfaces 580 between the devices 500a,b. In FIG. 18, an example of the data exchange is shown, with tile 4b sending data 590a to tile 4f.

Also shown in this example of FIG. 18, are tiles 4 belonging to sync zone Z2, which was discussed above with reference to FIGS. 15 and 16. As shown, sync zone Z2 comprises in addition to tiles 4c and 4d, which were discussed above with respect to FIG. 15, tiles 4h and 4g, which belong to processing unit 2c. The registers 53 of tiles 4c and 4d comprise indications that these tiles belong to sync zone Z2. Tiles 4c and 4d, when they reach the barrier synchronisation for Z2, each issue a tile sync request towards the sync controller 55 of device 500a in the manner described above with respect to FIG. 15. In the same manner, tiles 4h and 4g when they reach the barrier synchronisation for Z2, each issue a tile sync request towards the sync controller 55 of device 500c. In response, each of these sync controllers 55 forwards external sync requests to the GSPs 58 of their devices 500a, 500c. In the manner described above with reference to FIG. 17, the GSPs 58 of devices 500a, 500c exchange an external sync request and an external sync acknowledgement and then cause internal sync acknowledgments to be sent (via the sync controller 55 of their device 500a,b) to the tiles 4c,d,h,g of the device 500a, 500c to which they belong. Data exchange then takes place between one or more of tiles 4c,d and one or more of tiles 4h,g via interfaces 580 between the devices 500a,c. In the example of FIG. 18, tile 4d is shown as sending data 590b to tile 4g.

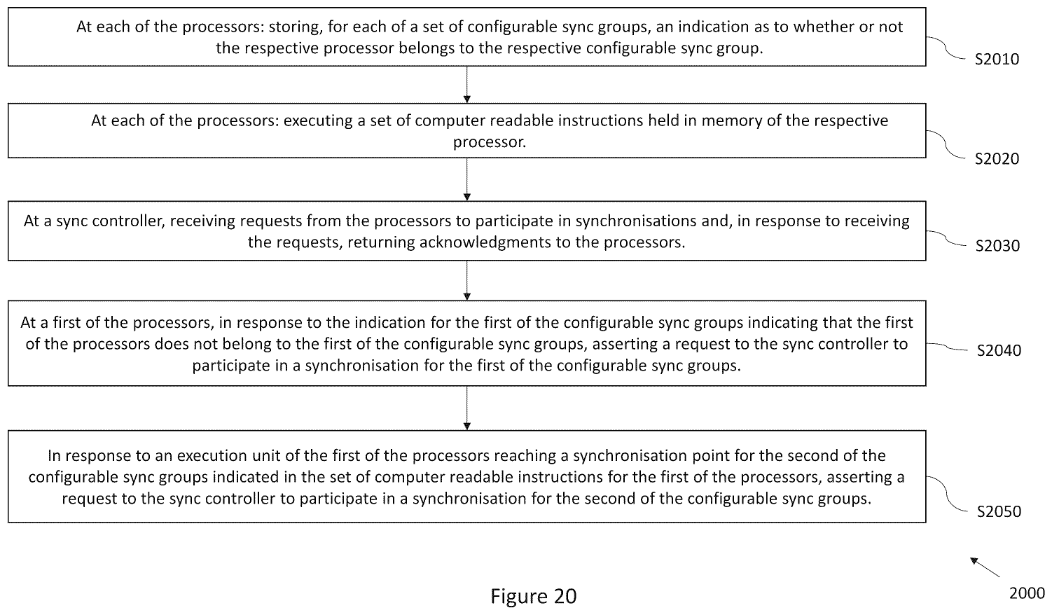

Reference is made to FIG. 20, which illustrates a method 2000 for co-ordinating synchronisations between the processors 4 based on configurable sync groups (i.e. the sync zones discussed above). The method is performed on a single device 500.

At 52010, for each processor 4, the indications as to which sync zones, the respective processor 4 belongs are stored in the register 53 of the processor. Each of the processors 4 stores in its register 53, an indication for each of the sync zones, whether or not that processor 4 belongs to the respective sync zone.

At S2020, each of the processors 4 executes instructions held in its memory 51. S2020 may be performed at the same time as other steps in method 2000 are being performed.

At S2030, the sync controller 55 of the device 500 receives sync requests from the processors 4, and in response, returns sync acknowledgments. The sync requests are received at the sync controller 55 in the form of aggregated (or internal) sync requests that result from the individual tile sync requests. These tile sync requests include the requests issued at S2040 and S2050. Hence, S2030 is not complete when S2040 and S2050 are performed.

At S2040, a first of the processors 4, which does not belong to a first sync zone, issues a sync request for the first sync zone. The first of the processors 4 asserts the request in response to the indication in the register 53 of the first of the processors 4 that the first of the processors 4 does not belong the first sync zone. The first of the processors 4 at which S2040 is performed may, for example, be the tile 4c shown in FIG. 15, with the first sync zone being Z1.

After S2040, the sync controller 55 may, once all of the processors have asserted a sync request for Z1, return acknowledgments to all of the processors 4 in the device 500.

At S2050, a first of the processors 4, which does belong to a second sync zone, issues a sync request for the second sync zone. The first of the processors 4 asserts the request in response to the execution unit 52 reaching a synchronisation point (e.g. barrier) for the second sync zone in its code in memory 51. When it reaches this synchronisation point, the execution unit 52 executes a SYNC instruction to cause the sync request to be asserted. The second of the processors 4 at which S2040 is performed may, for example, be the tile 4c shown in FIG. 15, with the second sync zone being Z2.

After S2050, the sync controller 55 may, once all of the processors have asserted a sync request for the second sync zone, return acknowledgments to all of the processors 4 in the device 500.

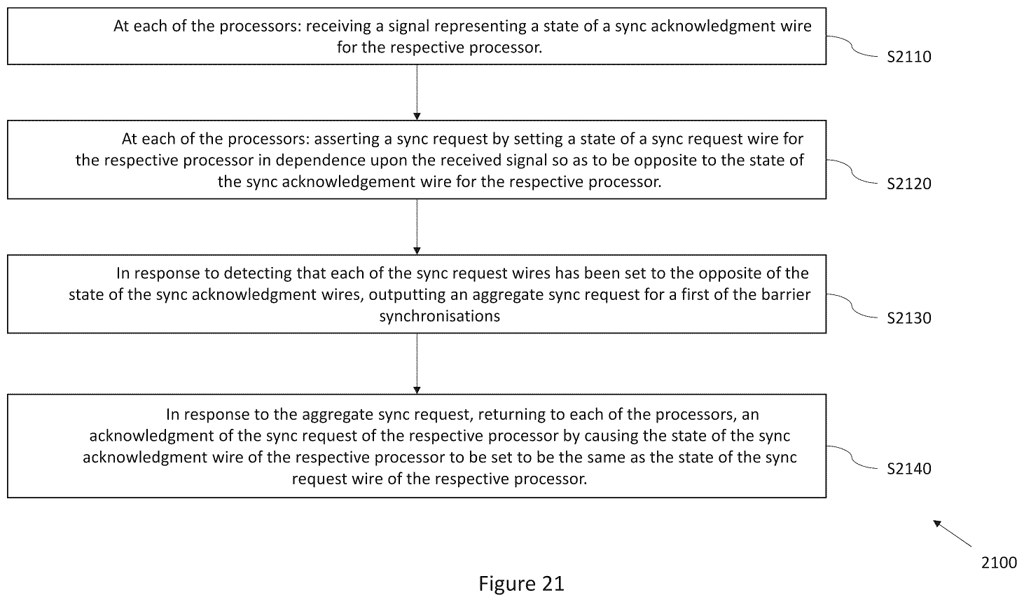

Reference is made to FIG. 21, which illustrates a method 2100 for co-ordinating synchronisations using a new scheme for signalling sync requests and acknowledgments. The method 2100 is performed by a single device 500.

At 52110, each of the processors 4, receives a signal representing a state of a sync acknowledgment wire for the respective processor 4. Each such sync acknowledgment wire on which the signal is received at 52110 is associated with the same sync zone. Each such signal received at each of the processors represents the same state (i.e. either high or low).

At 52120, each of the processors 4, asserts a sync request by setting the state of the sync request wire for the respective processor in dependence upon the received signal so as to be the opposite to the state of the sync acknowledgment wire for the respective processor 4.

At 52130, the aggregation circuitry 920, 910, in response to detecting that each of the sync request wires has been set to the opposite of the state of the sync acknowledgment wires, outputs an aggregate sync request (i.e. an internal sync request) for a first of the barrier synchronisations to the sync controller 55.

At 52140, in response to the aggregate sync request, the sync controller 55 returns a sync acknowledgment to each of the processors 4. This is achieved for each processor 4, by causing the state of the sync acknowledgment wire of the respective processor 4 to be set to be the same as the state of the sync request wire of the respective processor 4.

It would be appreciated that the above embodiments have been described by way of example only. In particular, it would be appreciated that although examples have been described in which the synchronisation points are BSP barrier synchronisations, in other embodiments, the synchronisation points may be different types of synchronisation points.

1. A data processing device comprising:
a plurality of processors, each comprising an execution unit configured to participate in at least one of a plurality of barrier synchronisations; and
a plurality of sets of wiring for co-ordinating the barrier synchronisations between the processors, wherein each of the sets of wiring is associated with a respective one of the processors and comprises a sync request wire and a sync acknowledgment wire, wherein for each of the processors, circuitry of the respective processor is configured to:
receive a signal representing a state of the sync acknowledgment wire for the respective processor;
assert a sync request by setting a state of the sync request wire for the respective processor in dependence upon the received signal, so as to be opposite to the state of the sync acknowledgement wire for the respective processor,
wherein the data processing device further comprises:
aggregation circuitry configured to, in response to detecting that each of the sync request wires has been set to the opposite of the state of the sync acknowledgment wires, output an aggregate sync request for a first of the barrier synchronisations to the sync controller;
a sync controller comprising circuitry configured to, in response to the aggregate sync request, return to each of the processors, an acknowledgment of the sync request of the respective processor by causing the state of the sync acknowledgment wire of the respective processor to be set to be the same as the state of the sync request wire of the respective processor.

2. The data processing device of claim 1, wherein the circuitry of the sync controller is configured to, for each of the processors, perform the causing the state of the sync acknowledgment wire for the respective processor to be set by setting the state of the sync acknowledgment wire for the respective processor in dependence upon the aggregate sync request so as to be the same as state of a wire on which the aggregate sync request is provided.

3. The data processing device of claim 1, wherein the aggregation circuitry is configured to output the aggregate sync request on an aggregate sync request wire to the sync controller by:
following a transition in the state of all of the sync request wires to an updated state, updating a state of the aggregate sync request wire to match the updated state of all of the sync request wires.

4. The data processing device of claim 1, wherein the aggregation circuitry comprising a plurality of aggregation circuits, each of which is associated with a set of one or more of the processors and is configured to aggregate the state of the sync request wires of its associated processors with running aggregate state.

5. The data processing device of claim 1, wherein for at least some of the processors, the respective execution unit is configured to, in response to the acknowledgment from the sync controller, proceed past the first of the barrier synchronisations.

6. The data processing device of claim 1, wherein each of the processors comprises:
a memory storing a local program comprising a set of computer readable instructions, the respective set of computer readable instructions comprising indications of each of ones of the barrier synchronisations in which the respective processor is to participate; and
an execution unit configured to execute the computer readable instructions of the respective processor so as to enable the respective processor to participate in ones of the barrier synchronisations.

7. The data processing device of claim 6, wherein for each of at least some of the processors:
the respective execution unit is configured to, in response to a first of the indications for the first of the barrier synchronisations, execute a sync instruction to cause the circuitry of the respective processor to assert the sync request for the respective processor.

8. The data processing device of claim 1, wherein for each of the processors, the respective execution unit is configured to operate in an alternating cycle of compute phases and exchange phases separated by the barrier synchronisations.

9. The data processing device of claim 8, wherein for each of at least some of the processors, the respective execution unit is configured to:
in response to receipt of the acknowledgment of the sync request of the respective processor, proceed to one of the exchange phases in which each of the at least some of the processors at least one of: sends or receives data.

10. The data processing device of claim 1, wherein a subset of the processors each comprise a register storing an indication that the processor does not belong to a group of processors that are configured to participate in the first of the barrier synchronisations,
wherein for each of the subset of the processors, the circuitry of the respective processor is configured to assert the sync request for the respective processor in response to the indication that the respective processor does not belong to the group.

11. The data processing device of claim 10, wherein for each of the subset of the processors:
an execution unit of the respective processors is configured to, following assertion of the sync request by the circuitry of the respective processor and prior to receipt of the acknowledgment, proceed with computation or data exchange without waiting at the first of the barrier synchronisations.

12. The data processing device of claim 9, wherein a subset of the processors each comprise a register storing an indication that the processor does not belong to a group of processors that are configured to participate in the first of the barrier synchronisations,
wherein for each of the subset of the processors, the circuitry of the respective processor is configured to assert the sync request for the respective processor in response to the indication that the respective processor does not belong to the group;
wherein for each of the subset of the processors:
an execution unit of the respective processors is configured to, in response to the indication that the processor does not belong to the sync group, abstain from participating in the one of the exchange phases.

13. The data processing device of claim 1, wherein the circuitry of the sync controller is configured to:
in response to the aggregate sync request, issue a further request to an external sync controller for the processors to participate in the first of the barrier synchronisations with further processors belonging to further devices; and
subsequently, in response to receipt of a further acknowledgment of the further request from the external sync controller, return to each of the processors, the acknowledgment of the sync request of the respective processor.

14. The data processing device of claim 1, wherein for each of the processors, the respective sync request wire and the respective sync acknowledgment are associated with a first sync group to which at least some of the processors belong.

15. The data processing device of claim 14, comprising, for each of the processors, the respective set of sync wiring comprising:
a plurality of further sync request wires, each of which is associated with a different sync group and is operable to transport sync requests for ones of the barrier synchronisations involving the respective sync group; and
a plurality of further sync acknowledgment wires, each of which is associated with a different sync group and is operable to transport sync acknowledgments in relation to ones of the barrier synchronisations involving the respective sync group.

16. The data processing device of claim 15, wherein each of the different sync groups is a configurable sync group,
wherein each of the processors comprises a register comprising an indication, for each of the configurable sync groups, whether or not the respective processor belongs to that configurable sync group.

17. The data processing device of claim 1, wherein for each of the processors, the circuitry comprises at least one of:
an inverter gate configured to invert the signal representing the state of the sync acknowledgment wire for the respective processor in order to set the state of the sync request wire for the respective processor to be opposite to the state of the sync acknowledgement wire for the respective processor; and
a XOR gate configured to invert the signal representing the state of the sync acknowledgment wire for the respective processor in order to set the state of the sync request wire for the respective processor to be opposite to the state of the sync acknowledgement wire for the respective processor.

18. The data processing device of claim 1, wherein for each of the processors:
the signal representing the state of the sync acknowledgment wire for the respective processor is a low signal;
the setting the state of the sync request wire for the respective processor comprises setting the state of sync request wire to a high state; and
the circuitry of the respective processor is configured to, following assertion of its sync request:
receive a further signal representing an updated state of the sync acknowledgment wire for the respective processor, the further signal being a high signal and representing the acknowledgment of the sync request of the respective processor;
assert a further sync request by setting the state of the sync request wire for the respective processor to a low state.

19. The data processing device of claim 1, wherein for each of at least some of the processors, the circuitry of the respective processor is configured to:
detect the acknowledgment of the sync request for the respective processor in response to detecting a transition in the state of the sync acknowledgment wire for the respective processor.

20. The data processing device of claim 1, wherein the data processing device is an integrated circuit.

21. A method for co-ordinating barrier synchronisations between processors of a data processing device, the method comprising:
at each of the processors:
receiving a signal representing a state of a sync acknowledgment wire for the respective processor;
asserting a sync request by setting a state of a sync request wire for the respective processor in dependence upon the received signal so as to be opposite to the state of the sync acknowledgement wire for the respective processor,
in response to detecting that each of the sync request wires has been set to the opposite of the state of the sync acknowledgment wires, outputting an aggregate sync request for a first of the barrier synchronisations; and
in response to the aggregate sync request, returning to each of the processors, an acknowledgment of the sync request of the respective processor by causing the state of the sync acknowledgment wire of the respective processor to be set to be the same as the state of the sync request wire of the respective processor.
